(19) United States
(12) Patent Application Publication
(10) Pub. No.: US 2023/0222626 A1
(43) Pub. Date: Jul. 13, 2023

(54) METHOD AND APPARATUS ENCODING/DECODING A NEURAL NETWORK FEATURE MAP

(71) Applicants: Electronics and Telecommunications Research Institute, Daejeon (KR); HANBAT NATIONAL UNIVERSITY INDUSTRY-ACADEMIC COOPERATION FOUNDATION, Daejeon (KR)

(72) Inventors: Soon-Heung JUNG, Daejeon (KR); Sang Woon KWAK, Daejeon (KR); Joung-Il Yun, Daejeon (KR); Hae-Chul CHOI, Daejeon (KR); Hee-Ji HAN, Daejeon (KR)

(73) Assignees: Electronics and Telecommunications Research Institute, Daejeon (KR); HANBAT NATIONAL UNIVERSITY INDUSTRY-ACADEMIC COOPERATION FOUNDATION, Daejeon (KR)

(21) Appl. No.: 18/095,420

(22) Filed: Jan. 10, 2023

(30) Foreign Application Priority Data
Jan. 10, 2022 (KR) 10-2022-0003596
Oct. 13, 2022 (KR) 10-2022-0131753

(51) Int. Cl. G06T 3/40

(52) U.S. Cl. CPC G06T 3/4046; G06T 3/4007

(57) ABSTRACT

A neural network feature decoding method and apparatus according to the present disclosure receives a bitstream including an encoded feature, decodes a feature from a bitstream, and reconstructs features corresponding to a plurality of layers of a neural network based on a decoded feature.

### CROSS REFERENCE TO RELATED APPLICATIONS

The present application claims priority under 35 U.S.C. 119(a) to Korean Patent Applications No. 10-2022-0003596, filed on Jan. 10, 2022, and No. 10-2022-0131753, filed on Oct. 13, 2022, in the Korean Intellectual Property Office, which are incorporated herein by reference in their entirety.

### BACKGROUND OF DISCLOSURE

### Field of the Disclosure

The present invention relates to a method and apparatus for encoding/decoding a neural network feature map.

### Related Art

As the industrial field to which deep neural networks using deep learning is applied expands, the application of deep neural networks to industrial machines is increasing. For use in applications utilizing machine-to-machine communication, compression methods that consider not only human visual characteristics but also characteristics that play an important role in deep neural networks within machines are being actively studied.

### SUMMARY

The present disclosure provides a method and apparatus for encoding/decoding a neural network feature map.

A neural network feature decoding method and apparatus according to the present disclosure receives a bitstream including an encoded feature, decodes the feature from the bitstream, and reconstructs features corresponding to a plurality of layers of a neural network based on the decoded feature. Here, the encoded feature may include one or more features extracted from at least one image.

In the neural network feature decoding method and apparatus according to the present disclosure, the features corresponding to the plurality of layers may be reconstructed according to a reconstruction order of a bottom-up structure.

In the neural network feature decoding method and apparatus according to the present disclosure, the bottom-up structure may be a structure in which features corresponding to each layer are reconstructed in order from the lowest layer to the highest layer among the plurality of layers.

In the neural network feature decoding method and apparatus according to the present disclosure, reconstructing may comprise reconstructing, from the decoded feature, a first feature corresponding to a first layer among the plurality of layers, and reconstructing a second feature corresponding to a second layer among the plurality of layers based on at least one of the decoded feature or the first feature of the first layer.

In the neural network feature decoding method and apparatus according to the present disclosure, the first feature of the first layer may have a larger size than the second feature of the second layer.

In the neural network feature decoding method and apparatus according to the present disclosure, the first feature may be reconstructed by upsampling the decoded feature, and the upsampling may be performed based on any one of nearest neighbor interpolation (nn.interpolation) or pixel shuffle (nn.PixelShuffle).

In the neural network feature decoding method and apparatus according to the present disclosure, reconstructing the second feature may comprise upsampling the decoded feature and downsampling the pre-reconstructed first feature.

In the neural network feature decoding method and apparatus according to the present disclosure, the second feature may be reconstructed based on a sum of the upsampled decoded feature and the downsampled first feature.

In the neural network feature decoding method and apparatus according to the present disclosure, a scaling factor for the upsampling may be determined based on a ratio between a feature size corresponding to a reference layer and a feature size corresponding to the second layer. Here, the reference layer may be the highest layer among the plurality of layers.

In the neural network feature decoding method and apparatus according to the present disclosure, a scaling factor for the downsampling may be determined based on a ratio between a feature size corresponding to the first layer and a feature size corresponding to the second layer.

In the neural network feature decoding method and apparatus according to the present disclosure, features corresponding to the plurality of layers may be reconstructed according to a reconstruction order of a top-down structure.

In the neural network feature decoding method and apparatus according to the present disclosure, the top-down structure may be a structure in which features corresponding to each layer are reconstructed in an order from a highest layer to a lowermost layer among the plurality of layers.

In the neural network feature decoding method and apparatus according to the present disclosure, reconstructing may comprise reconstructing, from the decoded feature, a first feature corresponding to a first layer among the plurality of layers, and recontructing a second feature corresponding to a second layer among the plurality of layers based on at least one of the decoded feature or the first feature of the first layer.

In the neural network feature decoding method and apparatus according to the present disclosure, the first feature of the first layer may have a smaller size than the second feature of the second layer.

In the neural network feature decoding method and apparatus according to the present disclosure, the decoded feature may be identically set as the first feature corresponding to the first layer.

In the neural network feature decoding method and apparatus according to the present disclosure, reconstructing the second feature may comprise upsampling the decoded feature, upsampling the pre-reconstructed first feature, and calculating a sum of the upsampled decoded feature and the upsampled first feature.

In the neural network feature decoding method and apparatus according to the present disclosure, a scaling factor for upsampling the decoded feature may be determined based on a ratio between a feature size corresponding to a reference layer and a feature size corresponding to the second layer. Here, the reference layer may be a highest layer among the plurality of layers.

In the neural network feature decoding method and apparatus according to the present disclosure, a scaling factor for upsampling the pre-reconstructed first feature may be determined based on a ratio between a feature size corresponding to the first layer and a feature size corresponding to the second layer.

In the neural network feature decoding method and apparatus according to the present disclosure, reconstructing the second feature may further comprise performing convolution on a sum of the upsampled decoded feature and the upsampled first feature.

A computer-readable storage medium for storing a bitstream to be decoded by the neural network feature decoding method may be provided.

A computer-readable storage medium for storing a bitstream encoded by the neural network feature encoding method may be provided.

According to the present disclosure, the encoding/decoding efficiency of a neural network feature map can be improved.

### BRIEF DESCRIPTION OF THE DRAWINGS

FIG. 1 schematically illustrates a feature map encoding method performed by an encoding apparatus according to the present disclosure.

FIGS. 2, 3, 4, 5, 6, 7, 8A, 8B, 9A, 9B, 10A, and 10B illustrate a feature map acquisition method according to the present disclosure.

FIGS. 11, 12, 13A, 13B, 14, 15, 16A to 16D, 17, and 18 illustrate a feature map fusion method according to the present disclosure.

FIGS. 19 to 22 illustrate a feature map packing method according to the present disclosure.

FIG. 23 schematically illustrates a feature map decoding method performed by a decoding apparatus according to the present disclosure.

FIGS. 24 and 25 illustrate a feature map inverse-packing method according to the present disclosure.

FIGS. 26 and 27 illustrate a feature map reconstruction method according to the present disclosure.

FIGS. 28 and 29 illustrate a feature map reconstruction method based on a bottom-up structure according to the present disclosure.

FIGS. 30 to 32 illustrate a feature map reconstruction method based on a top-down structure according to the present disclosure.

### DESCRIPTION OF EMBODIMENTS

As the present disclosure may make various changes and have multiple embodiments, specific embodiments are illustrated in a drawing and are described in detail in a detailed description. But, it is not to limit the present disclosure to a specific embodiment, and should be understood as including all changes, equivalents and substitutes included in an idea and a technical scope of the present disclosure. A similar reference numeral in a drawing refers to a like or similar function across multiple aspects. A shape and a size, etc. of elements in a drawing may be exaggerated for a clearer description. A detailed description on exemplary embodiments described below refers to an accompanying drawing which shows a specific embodiment as an example. These embodiments are described in detail so that those skilled in the pertinent art can implement an embodiment. It should be understood that a variety of embodiments are different each other, but they do not need to be mutually exclusive. For example, a specific shape, structure and characteristic described herein may be implemented in other embodiment without departing from a scope and a spirit of the present disclosure in connection with an embodiment. In addition, it should be understood that a position or an arrangement of an individual element in each disclosed embodiment may be changed without departing from a scope and a spirit of an embodiment. Accordingly, a detailed description described below is not taken as a limited meaning and a scope of exemplary embodiments, if properly described, are limited only by an accompanying claim along with any scope equivalent to that claimed by those claims.

In the present disclosure, a term such as first, second, etc. may be used to describe a variety of elements, but the elements should not be limited by the terms. The terms are used only to distinguish one element from other element. For example, without getting out of a scope of a right of the present disclosure, a first element may be referred to as a second element and likewise, a second element may be also referred to as a first element. A term of and/or includes a combination of a plurality of relevant described items or any item of a plurality of relevant described items.

When an element in the present disclosure is referred to as being “connected” or “linked” to another element, it should be understood that it may be directly connected or linked to that another element, but there may be another element between them. Meanwhile, when an element is referred to as being “directly connected” or “directly linked” to another element, it should be understood that there is no another element between them.

As construction units shown in an embodiment of the present disclosure are independently shown to represent different characteristic functions, it does not mean that each construction unit is composed in a construction unit of separate hardware or one software. In other words, as each construction unit is included by being enumerated as each construction unit for convenience of a description, at least two construction units of each construction unit may be combined to form one construction unit or one construction unit may be divided into a plurality of construction units to perform a function, and an integrated embodiment and a separate embodiment of each construction unit are also included in a scope of a right of the present disclosure unless they are beyond the essence of the present disclosure.

A term used in the present disclosure is just used to describe a specific embodiment, and is not intended to limit the present disclosure. A singular expression, unless the context clearly indicates otherwise, includes a plural expression. In the present disclosure, it should be understood that a term such as “include” or “have”, etc. is just intended to designate the presence of a feature, a number, a step, an operation, an element, a part or a combination thereof described in the present specification, and it does not exclude in advance a possibility of presence or addition of one or more other features, numbers, steps, operations, elements, parts or their combinations. In other words, a description of “including” a specific configuration in the present disclosure does not exclude a configuration other than a corresponding configuration, and it means that an additional configuration may be included in a scope of a technical idea of the present disclosure or an embodiment of the present disclosure.

Some elements of the present disclosure are not a necessary element which performs an essential function in the present disclosure and may be an optional element for just improving performance. The present disclosure may be implemented by including only a construction unit which is necessary to implement essence of the present disclosure except for an element used just for performance improvement, and a structure including only a necessary element except for an optional element used just for performance improvement is also included in a scope of a right of the present disclosure.

Hereinafter, an embodiment of the present disclosure is described in detail by referring to a drawing. In describing an embodiment of the present specification, when it is determined that a detailed description on a relevant disclosed configuration or function may obscure a gist of the present specification, such a detailed description is omitted, and the same reference numeral is used for the same element in a drawing and an overlapping description on the same element is omitted.

A feature map according to the present disclosure may mean one or more features extracted from at least one image, or may mean a 2-dimensional feature map having a predetermined width and height. Alternatively, it may mean a 3-dimensional feature map having a predetermined width, height, and channel size. Alternatively, the feature map according to the present disclosure may be a feature map extracted through a neural network, which may be referred to as a neural network feature map. Hereinafter, for convenience of explanation, the term ‘feature map’ will be used for description.

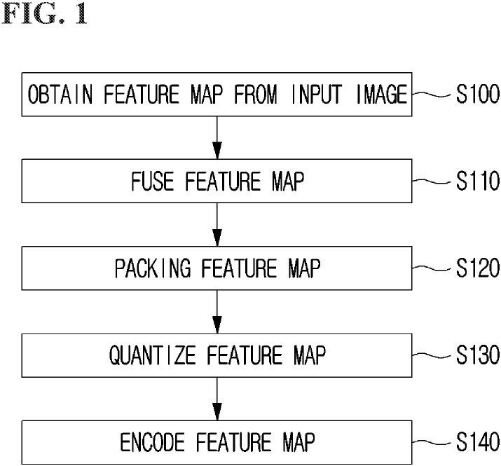

FIG. 1 schematically illustrates a feature map encoding method performed by an encoding apparatus according to the present disclosure.

The feature map encoding method may comprise at least one of [D1] feature map acquisition step, [D2] feature map fusion step, [D3] feature map packing step, [D4] feature map quantization step, or [D5] feature map encoding step. That is, for encoding of the feature map, all of the above-described steps D1 to D5 may be performed, or some steps may be omitted. Hereinafter, a detailed description will be made with reference to drawings.

Referring to FIG. 1, a feature map may be obtained from an input image (S100).

The input image may mean one or more pictures. Alternatively, the input image may refer to only a partial region within one or more pictures. For example, the partial region may refer to a region in which feature extraction is required, such as a region of interest, an object region, and a foreground region. The feature map may be extracted for one or more layers of the neural network, and feature sizes extracted for each layer may be different from each other.

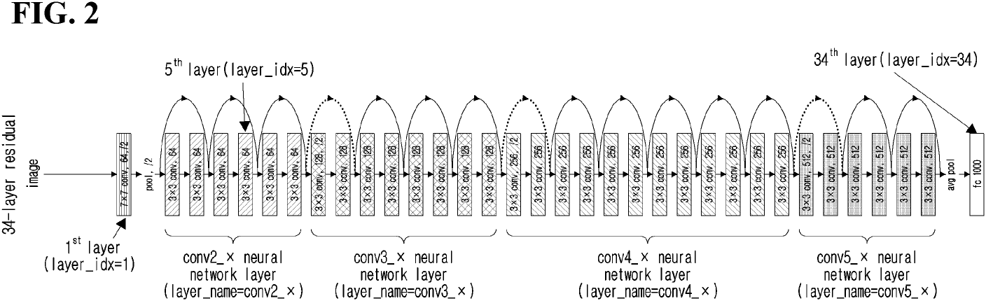

FIGS. 2 to 10 illustrate a feature map acquisition method according to the present disclosure, and with reference to these, the feature map acquisition method will be described in detail.

In acquiring the feature map, a predetermined first parameter may be determined/used. Here, the first parameter may include at least one of the neural network name (nn_name), the neural network layer name (layer_name), the layer number (layer_idx), the neural network splitting point (splitting_point), the number of feature maps (num_of_f), and the number of feature maps (f_idx), size information (n, m, k) of a single feature map, size information (nᵢ₋₁, mᵢ₋₁, kᵢ₋₁) of a multiple feature map, scaling factor (scaling_factor), side information transmission flag (side_info_flag), the number of channels (s_{c}) of side information, the horizontal size (s_{w}) of side information, or the vertical size (sₕ) of side information.

The neural network name (nn_name) may specify the entire neural network meta structure.

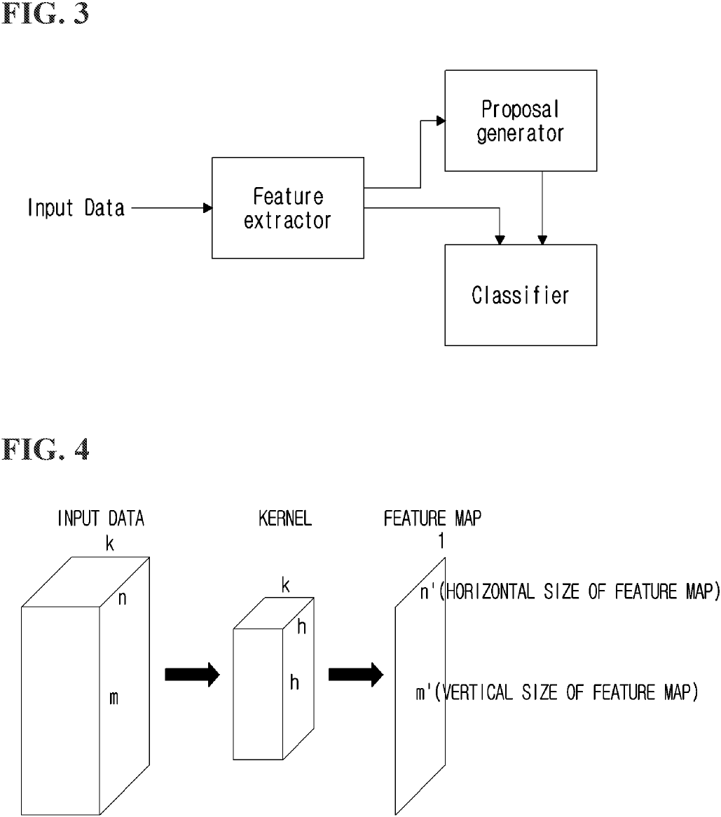

A neural network may be specified by a neural network name (nn_name). For example, by the neural network name, the neural network may be specified as at least one of Faster R-CNN, Mask R-CNN, JDETracker, VGGNet, or ResNet. As shown in FIG. 3, when the neural network name is Faster R-CNN, the neural network is specified as Faster R-CNN.

A syntax element (nn_name) specifying the neural network name may be signaled. For example, when the syntax element nn_name is a first value, the neural network name may be ResNet50. When the syntax element nn_name is a second value, the neural network name may be Faster R-CNN. When the syntax element nn_name is a third value, the neural network name may be Mask R-CNN. When the syntax element nn_name is a fourth value, the neural network name may be JDE Tracker.

A neural network may have one or more lower neural network layers, and at least one lower neural network layer may be specified by a neural network layer name (layer_name). For example, as shown in FIG. 2, the neural network Resnet34 may be composed of 34 neural network layers.

Alternatively, an upper neural network layer may be designated by a neural network layer name (layer_name). Here, the neural network layer name may designate one lower neural network layer or an upper neural network layer including a plurality of lower neural network layers. For example, the neural network layer name may designate at least one of C-layer, P-layer, Darknet-53, Resnet50, conv2_x, conv3_x, conv4_x, or conv5_x. (conv2_x is a layer name used in ResNet.) When the neural network layer name is C-layer, it may include all four lower neural network layers, that is, conv2_x, conv3_x, conv4_x, and conv5_x. Hereinafter, a neural network layer may be interpreted as a lower neural network layer or an upper neural network layer.

A syntax element (layer_name) specifying the neural network layer name may be signaled.

A neural network may have at least one neural network layer, and each neural network layer may be specified by a layer number.

Layer numbers of the neural network may be designated as a first layer number to a n-th layer number. Here, n may be a predetermined integer. For example, as shown in FIG. 2 , in the ResNet34 neural network, each neural network layer may be designated by a first layer number to a 34th layer number.

Layer numbers include a first layer number, a second layer number, ... , i-th layer number, ... , n-th layer number, and the like. The i-th layer number may refer to the i-th neural network layer (1≤i≤n). For example, as shown in FIG. 2, in the ResNet34 neural network, a first layer number refers to the first neural network layer. In the ResNet34 neural network, a fifth layer number refers to the fifth neural network layer. In the ResNet34 neural network, a 34th layer number refers to the 34th neural network layer.

A syntax element (layer_idx) designating layer number (i) may be signaled.

In the neural network feature map acquisition step, at least one of information on which neural network the feature map to be currently encoded is obtained from (neural network name), information on which layer of the neural network it is extracted from (neural network layer number), and information on at which point in the neural network the feature map is obtained (neural network splitting point), information on which layer of the feature map it is in the neural network (feature map number), or information on the size of the feature map (e.g., horizontal length, vertical length, channel length) may be determined/used.

In a neural network, one or more result values (or feature values) may be output by applying at least one filter (kernel) to an input value, and the result values here may be defined as a feature map. The feature map may be represented as 1D, 2D, or 3D array. A single feature map may be represented as a single 1D, 2D or 3D array. A 2D single feature map may be represented in terms of a horizontal size and a vertical size. A single 3D feature map may be represented in terms of a horizontal size, a vertical size, and a channel size. The number of feature values belonging to a single 2D feature map may be less than or equal to the product of the horizontal size and the vertical size. The number of feature values belonging to a single 3D feature map may be less than or equal to the product of a horizontal size, a vertical size, and a channel size.

A multiple feature map may be defined as a feature map that includes two or more single feature maps, and may be represented as two or more 1D, 2D, or 3D array. The multiple feature map may be composed of a plurality of single feature maps with the same dimension. For example, the multiple feature map may be composed of at least two or more 2D single feature maps. The multiple feature map may be composed of at least two or more 3D single feature maps. Alternatively, the multiple feature map may be composed of a plurality of single feature maps with different dimensions. For example, the multiple feature map may be composed of at least one 2D single feature map and at least one 3D single feature map. The multiple feature map may be represented by at least one of the number of single feature maps, a horizontal size, a vertical size, or a channel size for each single feature map. The number of feature values of the multiple feature map may be the sum of the number of feature values of each single feature map.

FIG. 3 illustrates Faster R-CNN as a representative meta structure of a neural network according to the present disclosure. As shown in FIG. 3, the meta structure of the neural network may include at least one of a feature extractor and a classifier. For example, the feature extractor may be at least one of VGGNet, Inception, Resnet, Darknet, or FPN. A feature extractor in a neural network may mean a backbone.

FIG. 4 illustrates a convolution operation of multi-channel data outputting a feature map of a 2D array according to the present disclosure. As shown in FIG. 4, one or more result values (or feature values) may be output by applying one filter (kernel) to an input value in the neural network, and the output result values may be defined as a single feature map. A single feature map may have a predetermined horizontal size n′, a predetermined vertical size m′, and one channel.

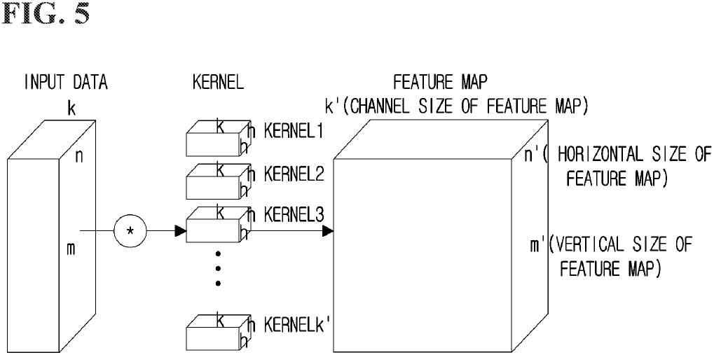

FIG. 5 illustrates a convolution operation for outputting a feature map of a 3D array according to the present disclosure. As shown in FIG. 5, a neural network may apply a predetermined number of filters (kernels) to an input value to output one or more result values (or feature values), and the output result values may be defined as a single feature map. Here, the predetermined number of filters may mean one filter or two or more filters. A single feature map may have a predetermined horizontal size n′, a predetermined vertical size m′, and a predetermined number of channels k′.

The multiple feature map may be composed of multiple single feature maps. Each single feature map may be designated as a first feature map to an n-th feature map by a feature map number. Here, n may be a predetermined integer.

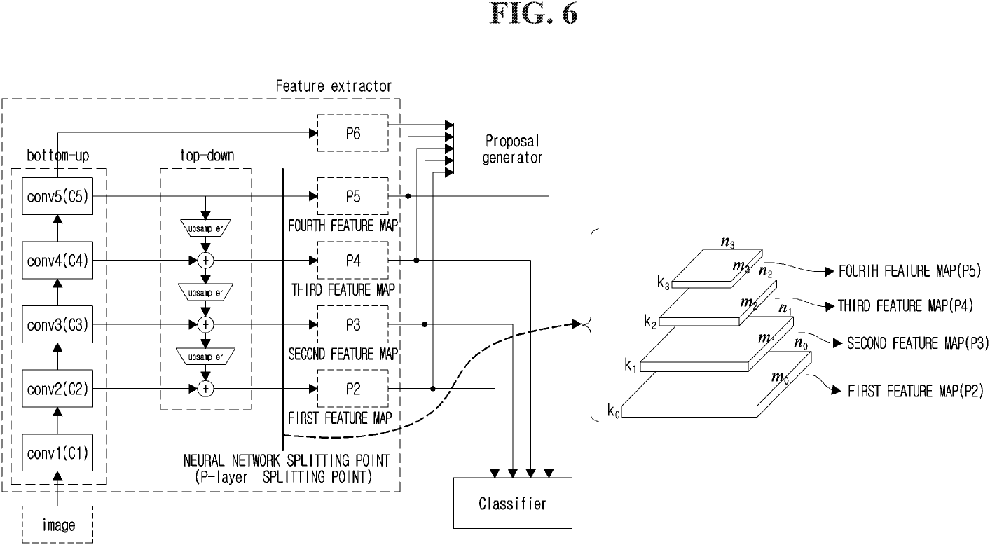

FIG. 6 is an example of the multiple feature map extracted from a feature extractor according to the present disclosure. As shown in FIG. 6, the multiple feature map may be composed of a first feature map, a second feature map, ... , the i-th feature map, ... , the n-th feature map. Here, the i-th feature map may mean a single feature map specified by feature map number i (1≤i≤n).

A syntax element (f_idx) specifying a feature map number may be signaled.

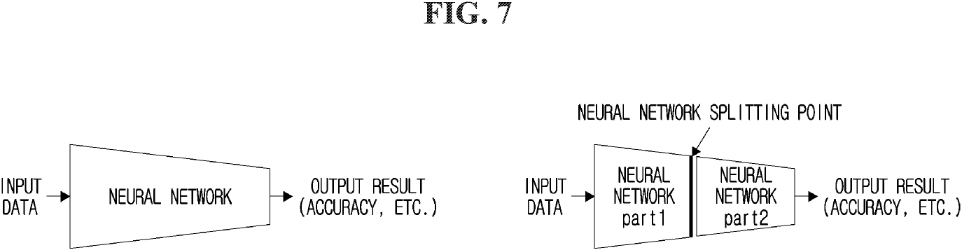

One or more neural network splitting points for dividing a neural network into a plurality of partial neural networks may be specified, and the single or multiple feature map having a predetermined number and/or a predetermined size may be obtained from the neural network splitting points. As shown in FIG. 7, the neural network may be divided into two partial neural networks (part1, part2) by a splitting point, and the single or multiple feature map may be extracted from the neural network splitting point.

The neural network splitting point may be specified based on at least one of an output position of a feature extractor in a neural network meta structure or one or more layer positions of a feature extractor. A feature map extracted from a neural network splitting point may be either a single feature map or a multiple feature map. For example, as shown in FIG. 6, a feature map generated from a neural network splitting point may be at least one of a single feature map or a multiple feature map.

The neural network splitting point may be a backbone output location of the neural network. For example, in Faster R-CNN, the neural network splitting point may be the output location of FPN, which is the backbone of Faster R-CNN.

A neural network splitting point may be specified as a layer name (layer_name) of the neural network. For example, the neural network splitting point may be specified as at least one of P-layer, C-layer, or Darknet-53, which are layer names of the neural network. Alternatively, the neural network splitting point may be specified as conv2_x (conv2_x is a layer name used in ResNet.).

A neural network splitting point may be specified by a layer number (layer_idx) of the neural network. For example, in Resnet50, the neural network splitting point may be the 10th layer. In Resnet50, the neural network splitting point may be the 50th layer.

A neural network splitting point may be specified based on a neural network name. For example, when the neural network name is Faster R-CNN, the neural network splitting point may be specified as the output location of the FPN of Faster R-CNN.

A syntax element (splitting_point) specifying a splitting point of the neural network may be signaled.

splitting_point may be a neural network name. For example, splitting_point may be Faster R-CNN. The splitting_point may be derived based on the neural network name (nn_name). splitting_point may be the name of a backbone. For example, splitting_point may be FPN. splitting_point may be a layer name. For example, splitting_point may be at least one of P-layer, C-layer, or Darknet-53. splitting_point may be a layer number. For example, splitting_point may be layer_idx. The splitting_point may be represented as a combination of at least two or more of the aforementioned neural network name, backbone name, layer name, or layer number. splitting_point may be signaled as an index.

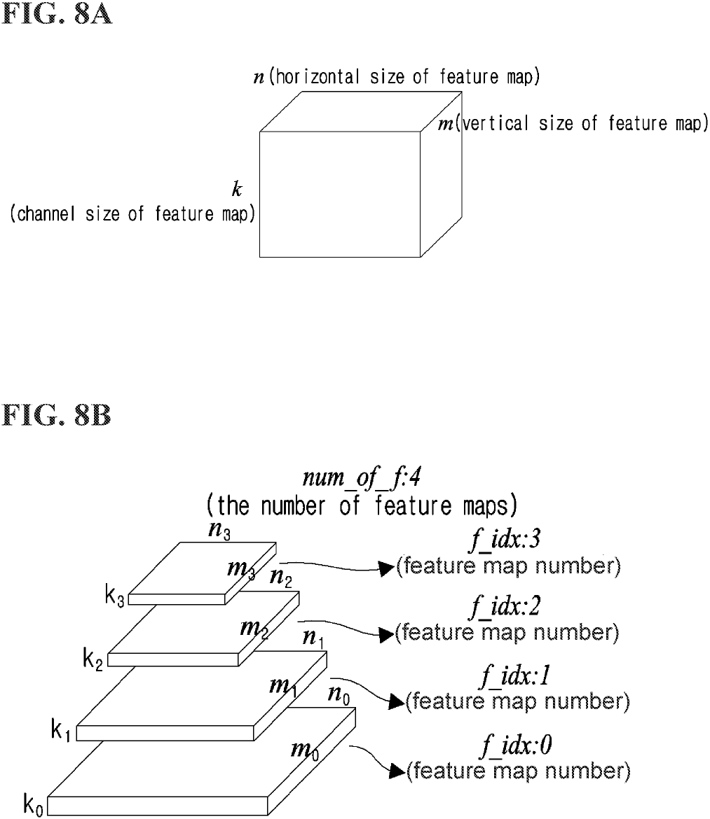

As shown in FIG. 8, size information of the single/multiple feature map may be obtained based on at least one of the number of feature maps, the feature map number, the feature map channel size, the feature map horizontal size, or the feature map vertical size of the single/multiple feature map. Here, the feature map number may be represented as 0, 1, ... N-1. Here, N is the total number of feature maps (num_of_f). Depending on the number of feature maps, whether the single or multiple feature map are may be determined. For example, when the number of feature maps (N) is equal to 1, the feature map number may be represented as 0, and the feature map in this case is defined as a single feature map. When the number of feature maps (N) is greater than or equal to 2, the feature map number may be represented as at least one of 0, 1, 2... N-1, and the feature maps in this case is defined as a multiple feature map.

Specifically, as shown in FIG. 8A, result values (or feature values) output by applying the predetermined number of filters (kernels) to input values in the neural network may be defined as a single feature map. A single feature map may have a predetermined channel size k, a predetermined horizontal size n, and a predetermined vertical size m.

As shown in FIG. 8B, result values (or feature values) output by applying the predetermined number of filters (kernels) to input values in the neural network may be defined as a multiple feature map. The multiple feature map may have the predetermined number of feature maps (num_of_f). Each feature map belonging to the multiple feature map may have a predetermined channel size (k_{f_idx}), a predetermined horizontal size (n_{f}__{idx}), and a predetermined vertical size (m_{f_idx}).

A single feature map may be composed of one or more channels. The feature map channel may be referred to as a first feature map channel, a second feature map channel, and the like by a channel number.

For example, as shown in FIG. 8A, when the number of feature maps (N) is 1, it may be designated as a single feature map. A single feature map may have k channels. The first feature map channel may be referred to as a first feature map channel, the second feature map channel may be referred to as a second feature map channel, and the last feature map channel may be referred to as a k-th feature map channel. Here, k is the total number of channels. The size of the first feature map channel may be represented as a predetermined feature map horizontal size n and a predetermined feature map vertical size m. In a single feature map, information of the feature map n, m, k may be signaled.

The multiple feature map may be composed of a plurality of single feature maps. That is, the multiple feature map may be composed of a plurality of feature maps. Each feature map of the multiple feature map may be referred to as a first feature map, a second feature map, and the like by a feature map number.

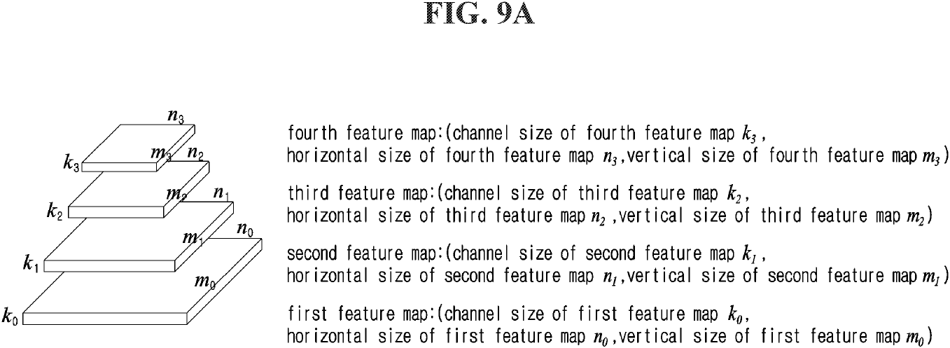

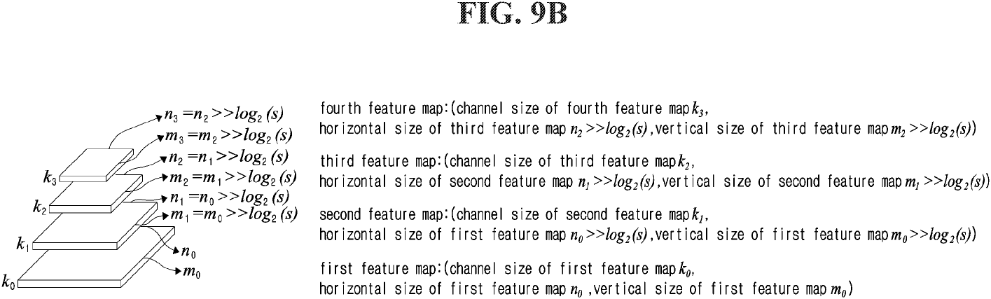

For example, as shown in FIG. 9A, when the number of feature maps (N) is greater than 1, it may be designated as a multiple feature map. Here, a first feature map may be composed of a first single feature map. A second feature map may be composed of a second single feature map. Similarly, an N-th feature map may be composed of an N-th single feature map.

As shown in FIG. 9A, the multiple feature map may be composed of N feature maps. The first feature map may be referred to as a first feature map, the second feature map may be referred to as a second feature map, and the last feature map may be referred to as an N-th feature map. Here, N may be the total number of feature maps.

As shown in FIG. 9A, the size of the first feature map may be represented as a predetermined feature map channel size (k₀), a predetermined feature map horizontal size (n₀), and a predetermined feature map vertical size (m₀). The size of the second feature map may be represented as a predetermined feature map channel size (k₁), a predetermined feature map horizontal size (n₁), and a predetermined feature map vertical size (m₁). The size of the i-th feature map may be represented as a predetermined feature map channel size (kᵢ₋₁), a predetermined feature map horizontal size (nᵢ₋₁), and a predetermined feature map vertical size (mᵢ₋₁) can be expressed as The size of the N-th feature map may be represented as a predetermined feature map channel size (k_{N-1}), a predetermined feature map horizontal size (n_{N-}₁), and a predetermined feature map vertical size (m_{N-1}).

In the multiple feature map, the information of each feature map, that is, the feature map channel size (kᵢ₋₁), the feature map horizontal size (nᵢ₋₁), and the feature map vertical size (mᵢ₋₁) may be signaled. (0≤i≤N-1)

The multiple feature map may be composed of a plurality of single feature maps. Each single feature map of the multiple feature map may be referred to as a first feature map, a second feature map, and the like by a feature map number. The size of each feature map may be represented by at least one of a scaling factor or the size of another feature map.

For example, as shown in FIG. 9B, the multiple feature map may be composed of N feature maps. The first feature map may be referred to as a first feature map, the second feature map may be referred to as a second feature map, and the last feature map may be referred to as an N-th feature map. Here, N may be the number of feature maps.

As shown in FIG. 9B, the size of a first feature map may be represented as a predetermined feature map channel size (k₀), a predetermined feature map horizontal size (n₀), and a predetermined feature map vertical size (m₀) of a first feature map. The size of a second feature map may be represented as a predetermined feature map channel size (k₁) of a second feature map, a feature map horizontal size (n₀) of a first feature map, a feature map vertical size (m₀) of a first feature map, and a scaling factor s. The size of the i-th feature map may be represented as a predetermined feature map channel size (kᵢ₋₁) of the i-th feature map, a feature map horizontal size (nᵢ₋₂) of the (i-1)-th feature map, a feature map vertical size (mᵢ₋₂) of the (i-1)-th feature map, and a scaling factor s. The size of the N-th feature map may be represented as a predetermined feature map channel size (k_{N-1}) of the N-th feature map, a feature map horizontal size (n_{N-2}) of the (N-1)-th feature map, a feature map vertical size (m_{N-2}) of the (N-1)-th feature map, and a scaling factor s.

At least one of the channel size (ki (0≤i≤N-1)) of each feature map described above, the feature map horizontal size of the first feature map (n₀), the feature map vertical size of the first feature map (m₀), and the scaling factor s, or the number of feature maps (num_of_f) may be signaled.

The feature map and side information may be obtained from the above-mentioned splitting point.

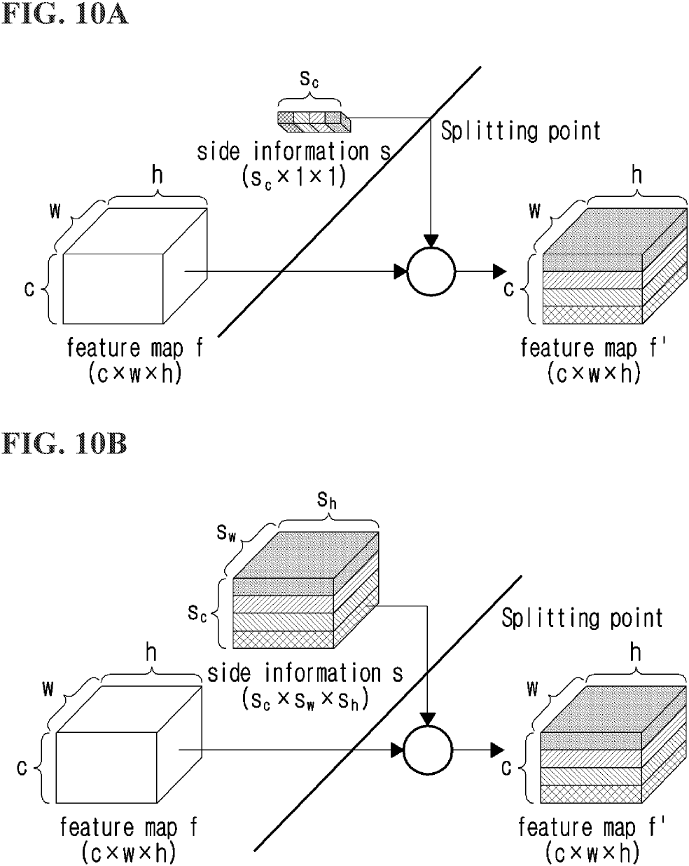

For example, as shown in FIG. 10A, a feature map f and side information s may be obtained. Here, the form of the side information s may be a 1D array form. Alternatively, as shown in FIG. 10B, the feature map f and the side information s may be obtained. Here, the form of the side information s may be a 3D array form.

The feature map and the side information may be encoded separately. The feature map and the side information may be separately signaled.

At least one of the channel size (s_{c}), the horizontal size (s_{w}), and the vertical size (sₕ) of the side information may be signaled. Alternatively, at least one of the channel size (s_{c}), the horizontal size (s_{w}), and the vertical size (sₕ) of the side information may be derived as a value of 1. For example, the channel size (s_{c}) may be signaled, and the horizontal size (s_{w}) and the vertical size (sₕ) may be derived as a value of 1. At least one of the channel size (s_{c}), the horizontal size (s_{w}), and the vertical size (sₕ) of the side information may be derived as the same value as the channel size, the horizontal size, and the vertical size of the feature map f. A side information transmission flag (side_info_flag) specifying whether side information is signaled may be signaled. For example, side_info_flag of a first value may indicate that side information is signaled, and side_info_flag of a second value may indicate that no side information is signaled.

At least one of information of the single feature map, information of the multiple feature map, or side information may be obtained by at least one of neural network name, neural network splitting point, the number of feature maps, feature map number, feature map horizontal size, feature map vertical size, scale factor, feature map channel size, feature map channel number, and side information transmission flag.

A syntax element (num_of_f) specifying the number of feature maps may be signaled. For example, when the syntax element num_of_f is a first value, the number of feature maps may be one. When the syntax element num_of_f is a second value, the number of feature maps may be two. When the syntax element num_of_f is a third value, the number of feature maps may be three. When the syntax element num_of_f is a fourth value, the number of feature maps may be four.

A syntax element (f_idx) specifying a feature map number may be signaled. For example, when the syntax element f_idx is a first value, it may indicate the first feature map. When the syntax element f_idx is a second value, it may indicate the second feature map. When the syntax element f_idx is a third value, it may indicate the third feature map. When the syntax element f_idx is a fourth value, it may indicate the fourth feature map.

Referring to FIG. 1, the obtained feature maps may be fused (S110).

The feature map fusion method according to the present disclosure may comprise at least one of arranging the size of the feature map, concatenating the feature map, emphasizing a channel of the feature map, or reducing a channel of the feature map. Specifically, in the step of arranging the size of the feature map, the size of the feature maps of the remaining layers may be downsampled to the size of the feature map of the reference layer. For example, the reference layer may mean the uppermost layer (P5) among P-layers of the neural network, but is not limited thereto. In the step of concatenating the feature map, feature maps extracted for each layer may be combined into one feature map. This may be performed after downsampling the feature size of the remaining layers to the feature size of the reference layer. In the step of emphasizing the channel of the feature map, predetermined channel weight information may be applied to the channel of the feature map. Also, in the step of reducing the channel of the feature map, the size or number of channels of the one feature map may be reduced through a convolution layer. Hereinafter, the feature map fusion method according to the present disclosure will be described in detail.

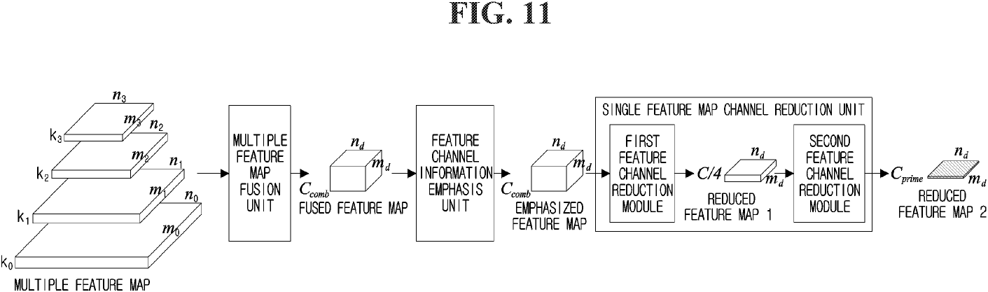

The feature map fusion method according to the present disclosure may comprise at least one of a multiple feature map fusion step in a multiple feature map fusion unit, a feature map channel emphasis step in a feature map channel emphasis unit, or a single feature map channel reduction step in a single feature map channel reduction unit. FIGS. 11 to 18 illustrate a feature map fusion method according to the present disclosure, and the feature map fusion method will be described in detail with reference to the feature map fusion method.

In the multiple feature map fusion step, a predetermined second parameter may be determined/used. Here, the second parameter may include at least one of the horizontal size (n_{d,f_idx}) of the downscaled feature map, the vertical size (m_{d,f_idx}) of the downscaled feature map, the horizontal size (n_{d}) of the fused feature map, the vertical size (m_{d}) of the fused feature map, or the channel size (C_{comb}) of the fused feature map.

In the multiple feature map fusion step, a process of fusing the multiple feature map obtained in step [D1] into a single feature map may be performed. As shown in FIG. 11, the feature map obtained through the multiple feature map fusion step may be represented by at least one of a predetermined channel size (C_{comb}), a predetermined horizontal size (n_{d}), or a predetermined vertical size (m_{d}).

In the multiple feature map fusion unit, the multiple feature map may be fused into a single feature map. An input of the multiple feature map fusion unit may be a single/multiple feature map obtained in step [D1]. When the input feature map is a single feature map, fusion of the multiple feature map may be omitted. When the input feature map are the multiple feature map, fusion of the multiple feature map may be performed.

The multiple feature map fusion unit may downscale the horizontal and vertical sizes of the feature map to a predetermined size for fusion of the multiple feature map. For downscaling, at least one of pooling and convolution may be used.

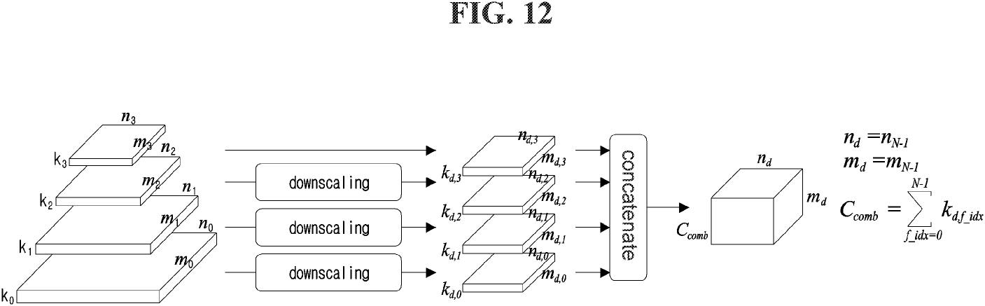

The horizontal and vertical sizes of the downscaled feature map may be represented as n_{d,f_idx} and m_{d,f_idx}, respectively. Here, f_idx means a feature map number. For example, FIG. 12 is an example of a feature map fusion method when the number of channels in each feature map layer is the same. As shown in FIG. 12, the horizontal sizes of the downscaled multiple feature map may be represented as n_{d,0}, n_{d,1}, .., n_{d,N-1}. As shown in FIG. 12, the horizontal sizes n_{d,0}, n_{d,1}, .., n_{d,N-1} of the downscaled multiple feature map may be the same as the predetermined sizes n_{N-1}. Here, n_{N-1} may be the horizontal size of the smallest single feature map among the multiple feature maps input to the multiple feature map fusion unit. Similarly, as shown in FIG. 12, the vertical sizes of the downscaled multiple feature map may be represented as m_{d,0}, m_{d,1}, .., m_{d,N-1}. As shown in FIG. 12, the vertical sizes m_{d,0}, m_{d,1}, .., m_{d,N-1} of the downscaled multiple feature map may be the same as the predetermined size m_{N-1}. Here, m_{N-1} may be the vertical size of the smallest single feature map among the multiple feature map input to the multiple feature map fusion unit.

The channel size of the downscaled feature map may be represented as k_{d,}_{f_idx}. For example, as shown in FIG. 12, the channel sizes of the downscaled multiple feature map may be represented as k_{d,0}, k_{d,1}, .., k_{d,N-1}. As shown in FIG. 12, the channel sizes k_{d,0}, k_{d,1}, .., k_{d,N-1} of the downscaled multiple feature map may be the same as predetermined sizes k₀, k₁, .., k_{N-1}. Here, k₀, k₁, .., k_{N-1} may be channel sizes of the multiple feature map input to the multiple feature map fusion unit.

At least one of the horizontal size n_{d,f_idx} or the vertical size m_{d,f_idx} of the downscaled feature map may be signaled (0 < f_idx < N-1, where N is the number of channels). The n_{N-1} may be signaled, and the horizontal sizes of all downscaled feature maps may be derived as n_{N-1}. The m_{N-1} may be signaled, and the vertical sizes of all downscaled feature maps may be derived as m_{N-1}.

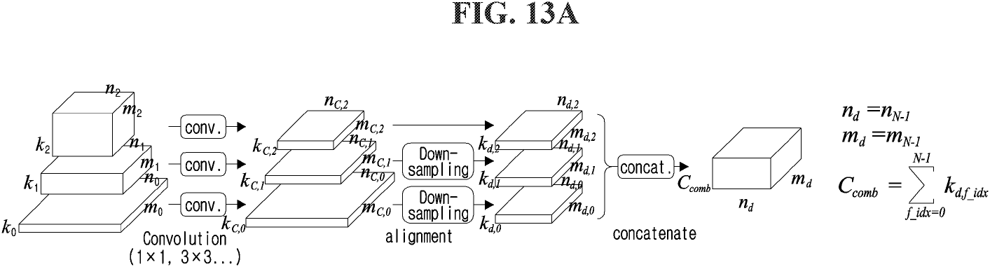

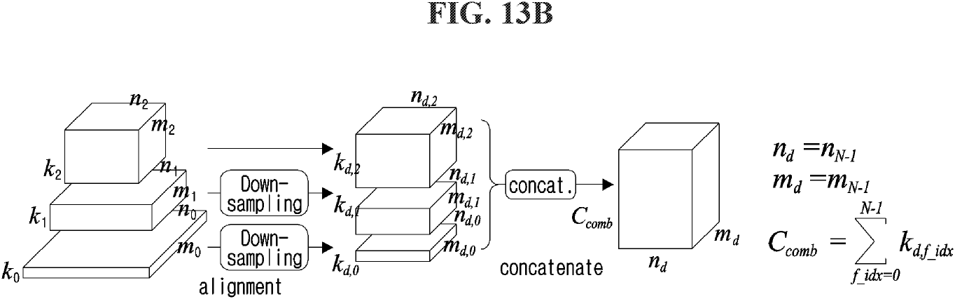

In the multiple feature map fusion unit, the feature maps may be fused by NxN convolution and concatenation processes. When channel sizes of feature maps of each layer are different, N×N convolution may be used. The kernel size N of the convolution layer may be at least one of 1, 3, 5, or 7. The channel size k₀, k₁, .., k_{N-1} of each feature map may be represented as k_{c,0}, k_{c,1}, .., k_{c,N-1} after performing N×N convolution. For example, FIG. 13 is an example of a feature map fusion method when the number of channels in each feature map layer is different. As shown in FIG. 13A, the channel sizes k_{c,0}, k_{c,1}, .., k_{c,N-1} of the feature map may be equal to k_{N-}₁, respectively. Here, k_{N-1} may be the channel size of the smallest single feature map among the multiple feature map input to the multiple feature map fusion unit.

The channel size of the fused feature map may be represented as C_{comb}, which is a predetermined feature map channel size, through a concatenation process. For example, as shown in FIGS. 13A and 13B, the channel size C_{comb} of the feature map may consist of the sum of k₀, k₁, .., k_{N-1} or the sum of k_{c,0}, k_{c,1}, .., k_{c,N-1}.

The horizontal and vertical sizes of the fused feature map may be referred to as n_{d} and m__{d}, respectively. At least one of n_{d} and m_{d} may be signaled.

If the feature map input in step [D2] is a single feature map, the fusion of the multiple feature map in the multiple feature map fusion unit may be omitted. In this case, the horizontal size, the vertical size, and the channel size of the input single feature map may be referred to n_{d}, m_{d}, and C_{comb}, respectively.

A syntax element (C_{comb}) specifying the number of kernels of a convolution layer in the multiple feature map fusion unit may be signaled. For example, when the syntax element C_{comb} is a first value, the number of kernels of the convolution layer may be 256. When the syntax element C_{comb} is a second value, the number of kernels of the convolution layer may be 512. When the syntax element C_{comb} is a third value, the number of kernels of the convolution layer may be 1024. When the syntax element C_{comb} is a fourth value, the number of kernels of the convolution layer may be 2048.

In the feature map channel emphasis step, a predetermined third parameter may be determined/used. Here, the third parameter may include at least one of whether a channel of the feature map is emphasized (is_emphasis_flag) or an emphasis mode of the feature map (emphasis_mode). At least one of is_emphasis_flag or emphasis_mode may be signaled. is_emphasis_flag is not signaled and may always be derived as a value of 1.

In the feature map channel emphasis step, a main channel of the feature map may be emphasized based on channel weight information. The channel weight information may be generated by GAP, SE-block, and the like.

The feature map channel information emphasis unit may emphasize a main channel of the feature map based on the channel weight information.

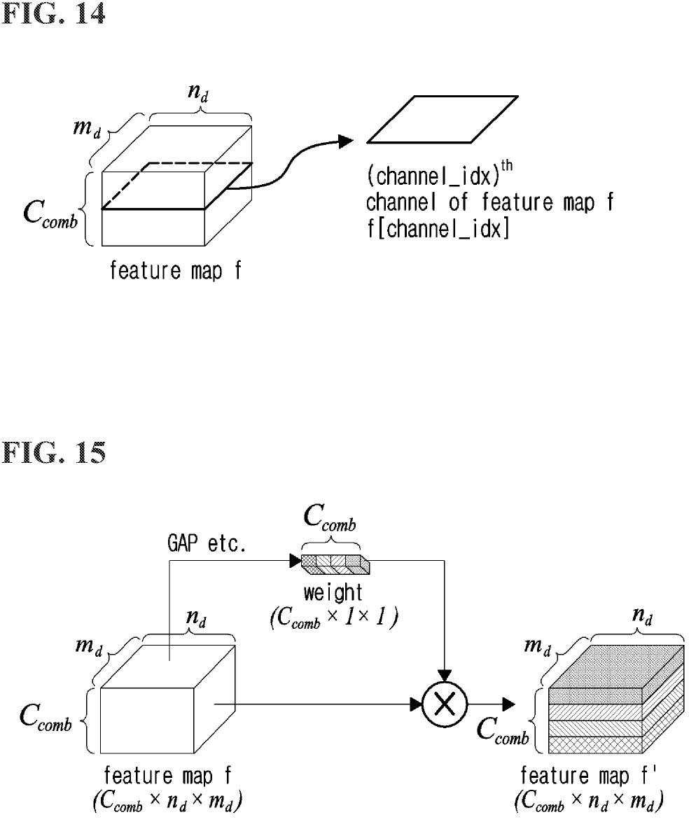

For example, as shown in FIG. 15, the channel weight information for the fused feature map, which is the output feature map of the multiple feature map fusion unit, may be generated by at least one of Global Average Pooling (GAP) or SE-block, and it may be called weight. As shown in FIG. 15 , the output feature map of the feature channel emphasis unit may be generated by applying channel weight information to the fused feature map.

For example, the output feature map of the feature channel emphasis unit may be generated by multiplying the fused feature map by channel weight information as shown in Equation 1 below.

$$\text{f′} \left[\text{channel\_idx}\right] = \text{f} \left[\text{channel\_idx}\right] * \text{w} \left[\text{channel\_idx}\right]$$

In Equation 1, f may mean a feature map emphasized by a weight, and channel_idx may mean an index indicating each channel of the feature map. w[channel_idx] is a weight value (scalar) for the channel of channel_idx, and f[channel_idx] may mean a fused feature map for the channel of channel_idx. f[channel_idx] may be a 2D Array of horizontal size n_{d} and vertical size m_{d}. f[channel_idx] * w[channel_idx] is an operation that multiplies all values of the channel_idx channel of f by w[channel_idx].

Whether to emphasize the channel of the feature map may be determined by is_emphasis_flag. For example, when is_emphasis_flag is a first value, channel emphasis of the feature map may be performed. When is_emphasis_flag is a second value, channel emphasis of the feature map may not be performed.

When is_emphasis_flag is a first value, at least one of feature map channel emphasis considering importance, feature map channel emphasis considering residual concatenation, feature map channel emphasis considering channel concatenation, or feature map channel emphasis using SE-Block may be performed to emphasize the channel of the feature map.

emphasis_mode may be signaled to indicate which of feature map channel emphasis considering importance, feature map channel emphasis considering residual concatenation, feature map channel emphasis considering channel concatenation, or feature map channel emphasis using SE-Block is used.

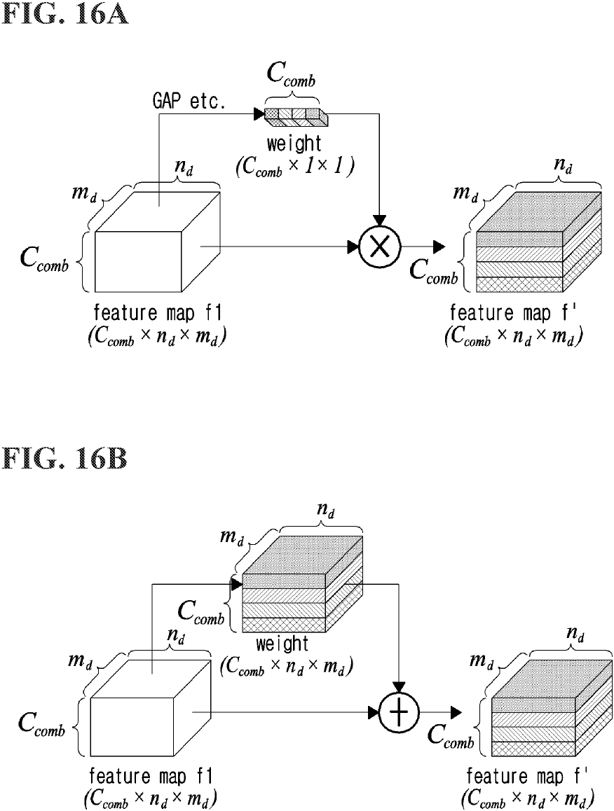

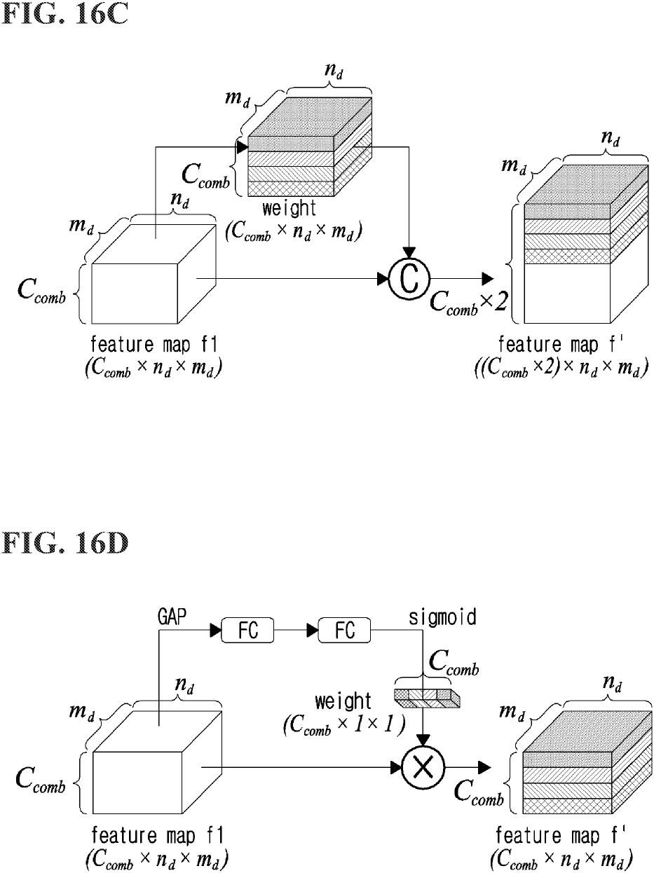

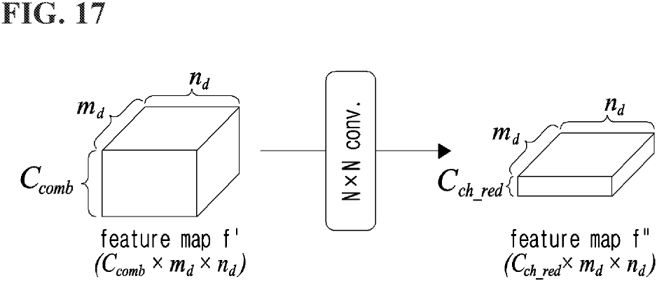

FIG. 16 illustrates a feature map emphasis method according to the present disclosure. Referring to FIG. 16, a feature map f1 may be an output feature map of a multiple feature map fusion unit.

As shown in FIG. 16A, when emphasis_mode is a first value, feature map channel emphasis considering importance may be performed. Specifically, channel weight information may be obtained in the form of (C_{comb}, 1, 1) by the channel size C_{comb} of feature map f1, and this channel weight information may be channel-wise multiplied with feature map f1.

As shown in FIG. 16B, when emphasis_mode is a second value, feature map channel emphasis considering residual concatenation may be performed. Specifically, channel weight information may be obtained in the form of (C_{comb}, n_{d}, m_{d}) by at least one of the channel size C_{comb} of feature map f1, the horizontal size n_{d} of feature map f1, or the vertical size m_{d} of feature map f1. This channel weight information may be element-wise summed with feature map f1.

As shown in FIG. 16C, when emphasis_mode is a third value, feature map channel emphasis considering channel concatenation may be performed. Specifically, the channel weight information may be obtained in the form of (C_{comb}, n_{d}, m_{d}) by at least one of the channel size C_{comb} of the feature map f1, the horizontal size n_{d} of the feature map f1, or the vertical size m_{d} of the feature map f1. This channel weight information may be concatenated with feature map f1.

As shown in FIG. 16D, when emphasis_mode is a fourth value, feature map channel emphasis using SE-Block may be performed. Specifically, channel weight information may be obtained in the form of (C_{comb}, 1, 1) by the channel size C_{comb} of feature map f1. This channel weight information may be channel-wise multiplied with feature map f1.

In the single feature map channel reduction step, a predetermined fourth parameter may be determined/used. Here, the fourth parameter may include at least one of whether to reduce a single feature map channel (is_red_flag), whether the feature channel reduction module is operated (is_red_modulel_flag), the number of kernels of N×N convolution layer of the feature channel reduction module (C_{ch_red}), whether to perform batch normalization (is_bn_enc), or an activation function mode (activation_function_{enc}).

A flag (is_red_flag) specifying whether to reduce a channel of a single feature map may be signaled. For example, when is_red_flag is a first value, reduction of a channel of a single feature map may be performed. When is_red_flag is a second value, reduction of a channel of a single feature map may not be performed. is_red_flag may always be derived as a first value without being signaled.

In the single feature map channel reduction unit, a flag (is_red_modulel_flag) specifying whether a first feature channel reduction module operates may be signaled. For example, when is_red1_flag is a first value, a first feature channel reduction module may operate. When is_red1_flag is a second value, a first feature channel reduction module may not operate. is_red_module1_flag may always be derived as a first value without being signaled.

In the single feature map channel reduction unit, a flag (is_red_module2_flag) specifying whether a second feature channel reduction module operates may be signaled. For example, when is_red2_flag is a first value, a second feature channel reduction module may operate. When is_red2_flag is a second value, a second feature channel reduction module may not operate. is_red_module2_flag may always be derived as a first value without being signaled.

In the single feature map channel reduction unit, a flag (is_bn_enc) specifying whether to perform batch normalization may be signaled. For example, when is_bn_enc is a first value, batch normalization may be performed. When is_bn_enc is a second value, batch normalization may not be performed. is_bn_enc may always be derived as a first value without being signaled.

The single feature map channel reduction unit may include one or more feature channel reduction modules, and at least one of the plurality of feature channel reduction modules may operate adaptively based on a parameter related to whether the feature channel reduction module operates.

In the single feature map channel reduction step, one or more feature channel reduction modules may operate. Here, for convenience of explanation, it is assumed that a first feature channel reduction module and a second feature channel reduction module are used.

As shown in FIG. 17, in a first feature channel reduction module, channels of the feature map may be reduced using an N×N convolution layer. For example, in an N×N convolution layer, N×N may be at least one of 1×1, 3×3, and 5×5. N×N is the kernel size of the convolution. The number of channels of the input feature map C_{comb} may be reduced to the number of channels of C_{comb}/4.

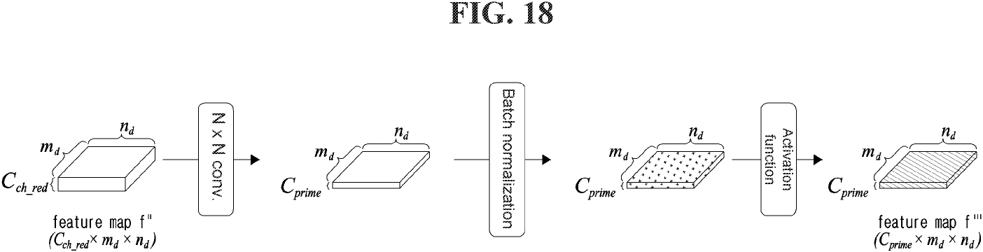

As shown in FIG. 18, a second feature channel reduction module may perform at least one of N×N convolution, batch normalization, or activation function.

Specifically, in a second feature channel reduction module, channels of the feature map may be additionally reduced using an N×N convolution layer. For example, as a result of a second feature channel reduction module, a feature map having the number of channels Cₚᵣᵢₘₑ may be obtained, where Cₚᵣᵢₘₑ may be at least one of 32, 64, 128, 256, or Ccomb/16.

Meanwhile, a second feature channel reduction module may change the feature distribution by performing batch normalization. In a second feature channel reduction module, the feature distribution may be changed by applying an activation function. For example, activation_function_{enc} indicating an activation function may be at least one of Sigmoid, tanh, or PReLU.

In the single feature map channel reduction unit, reduction of a single feature map channel may be performed based on at least one of a first feature channel reduction module or a second feature channel reduction module.

As shown in FIG. 17, the feature map f input to the single feature map channel reduction unit may be represented as a predetermined horizontal size n_{d}, a predetermined vertical size m_{d}, and a predetermined channel size C_{comb}. The first feature channel reduction module may reduce the channel size of the input feature map using an N×N convolution layer. Here, the N×N convolution layer may be at least one of 1×1, 3×3, and 5×5, and padding may be applied by (N-1)/2. For example, when an 1×1 convolution layer is used, padding may be 0. When a 3×3 convolution layer is used, padding may be 1. When a 5×5 convolution layer is used, padding may be 2.

The number of kernels of the N×N convolution layer of the first feature channel reduction module may be defined as C_{ch_red}. That is, the first feature channel reduction module may reduce the channel size of the feature map from C to C_{ch_red}. C_{ch_red} may be C/4.

C_{ch_red} may be derived as C/4. A syntax element (C_{ch_red}) specifying the number of kernels of the convolution layer in the first characteristic channel reduction module may be signaled. For example, when the syntax element C_{ch_red} is a first value, the number of kernels of the convolution layer may be 256. When the syntax element C_{ch_red} is a second value, the number of kernels of the convolution layer may be 512. When the syntax element C_{ch_red} is a third value, the number of kernels of the convolution layer may be 1024. When the syntax element C_{ch_red} is a fourth value, the number of kernels of the convolution layer may be 2048.

The second feature channel reduction module may reduce the channel size of the input feature map using an N×N convolution layer.

For example, as shown in FIG. 18, the N×N convolution layer may be at least one of 1×1, 3×3, and 5×5, and padding may be applied by (N-1)/2. For example, when an 1×1 convolution layer is used, padding may be 0. When a 3×3 convolution layer is used, padding may be 1. When a 5×5 convolution layer is used, padding may be 2.

As shown in FIG. 18, the number of kernels of the N×N convolution layer of the second feature channel reduction module may be defined as Cₚᵣᵢₘₑ. The second feature channel reduction module may reduce the channel size of the feature map from C_{comb} to Cₚᵣᵢₘₑ.

Cₚᵣᵢₘₑ may be specified with at least one size among 32, 64, 128, 256, or C_{ch_red}/4. Cₚᵣᵢₘₑ may be derived as C_{ch_red}/4. A syntax element (Cₚᵣᵢₘₑ) specifying the number of kernels of the convolution layer in the second feature channel reduction module may be signaled. For example, when the syntax element Cₚᵣᵢₘₑ has a first value, the number of convolution layer kernels may be 256. When the syntax element Cₚᵣᵢₘₑ is a second value, the number of kernels of the convolution layer may be 512. When the syntax element Cₚᵣᵢₘₑ is a third value, the number of kernels of the convolution layer may be 1024. When the syntax element Cₚᵣᵢₘₑ is a fourth value, the number of kernels of the convolution layer may be 2048.

The second feature channel reduction module may change the feature distribution by performing batch normalization. In the second feature channel reduction module, the feature distribution may be changed by applying an activation function.

For example, activation_function_{enc} indicating an activation function may be at least one of Sigmoid, tanh, and PReLU. activation_function_{enc} is a first value, the activation function may be Sigmoid. activation_function_{enc} is a second value, the activation function may be tanh. activation_function_{enc} is a third value, the activation function may be PReLU.

Referring to FIG. 1, the feature map may be packed (S120).

In packing the feature map, a predetermined fifth parameter may be determined/used. Here, the fifth parameter may include at least one of whether it is a multiple feature map (is_multiscale_packing), whether temporal/spatial packing is performed (is_temporal), the number of channels of the packed feature map (packed_channels), the horizontal size of the packed feature map (packed_width), or the vertical size of the packed feature map (packed_height).

A syntax element (is_multiscale_packing) specifying whether an input feature map is a multiple feature map may be signaled. For example, when the syntax element is_multiscale_packing is a first value, a feature map to be currently packed may be a multiple feature map. When the syntax element is_multiscale_packing is a second value, a feature map to be currently packed may be a single feature map.

A syntax element (is_temporal) specifying the packing method of the feature map may be signaled. For example, when the syntax element is_temporal is a first value, the feature map may be packed using a temporal packing method. When the syntax element is_temporal is a second value, the feature map may be packed using a spatial packing method.

The size of the packed feature map may be represented based on at least one of a horizontal size, a vertical size, or a channel size. A syntax element (packed_width) that specifies the horizontal size of the packed feature map may be signaled. As an example, the syntax element packed_width may be nₚ. nₚ will be described in a single feature map packing step/multiple feature feature map packing step to be described later. A syntax element (packed_height) that specifies the vertical size of the packed feature map may be signaled. As an example, the syntax element packed_height may be mₚ.

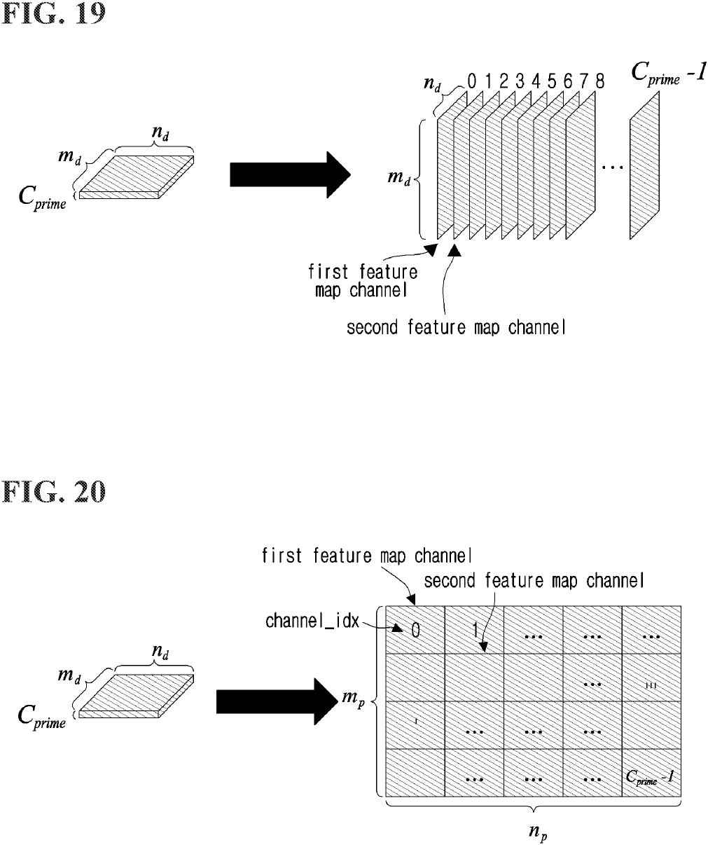

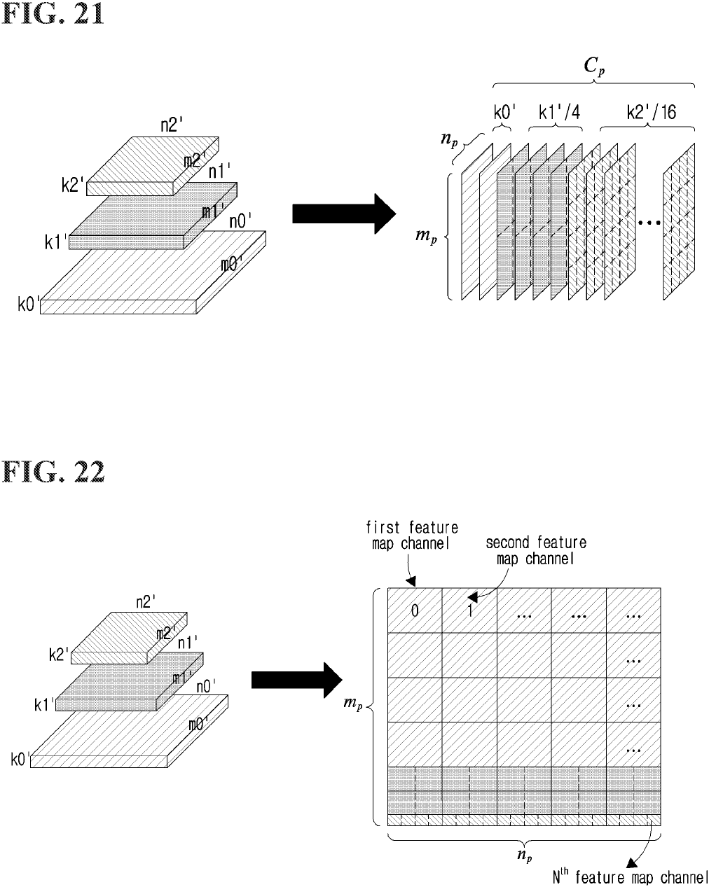

A syntax element (packed_frames) specifying the number of frames of the packed feature map may be signaled. As an example, as shown in FIG. 21 , the syntax element packed_frames may be cₚ. As shown in FIG. 19, the syntax element packed_frames may be Cₚᵣᵢₘₑ. As shown in FIGS. 20 and 22, the syntax element packed_frames may be 1.

A single feature map may be packed using at least one of a temporal packing method and a spatial packing method.

As shown in FIG. 19, in the temporal packing method, the feature map may be packed to have a feature map horizontal size of n_{d}, a feature map vertical size of m_{d}, and the number of frames Cₚᵣᵢₘₑ by arranging the feature map channels on the time axis.

As shown in FIG. 20, in the spatial packing method, the feature map may be packed to have a predetermined feature map horizontal size of nₚ, a predetermined feature map vertical size of mₚ, and one frame by reconstructing Cₚᵣᵢₘₑ feature map channels into one feature map channel.

The horizontal size n_{d} and the vertical size m_{d} of the feature map may be derived as in Equation 2 below.

$$\begin{matrix}\text{exp} \text{=} l o {g}_{2} \left({C}_{p r i m e}\right) \\ \text{row} \text{=} {\text{2}}^{e x p - \left(e x p ≫ 1\right)} , \text{col} \text{=} {\text{2}}^{e x p ≫ 1} \\ {n}_{p} = {n}_{d} \times r o w , {m}_{p} = {m}_{d} \times c o l\end{matrix}$$

The multiple feature map may be packed using at least one of a temporal packing method and a spatial packing method.

Each feature map of the multiple feature map may be arranged based on a horizontal size and/or a vertical size of the feature map, and each feature map may be arranged in a channel order. For example, a feature map having the largest horizontal and vertical sizes is referred to as a first feature map. A feature map having the second largest horizontal and vertical sizes is referred to as a second feature map.

A temporal packing method for the multiple feature map may be applied. For example, as shown in FIG. 21, the predetermined number of channels of the i-th feature map may be spatially packed based on the horizontal and vertical sizes of a first feature map and then temporally packed. In FIG. 21, Cₚ refers to the number of frames packed by the temporal packing method. Temporal packing may be performed as shown in FIG. 21.

A spatial packing method may be applied to the multiple feature map. For example, as shown in FIG. 22, in spatial packing, the feature map may be packed to have a predetermined feature map horizontal size nₚ, a predetermined feature map vertical size mₚ, and one frame by reconstructing k₀’, k₁’, ... kₙ₋₁’ feature map channels corresponding to a first feature map, a second feature map, ..., the N-th feature map into one feature map channel. Spatial packing may be performed as shown in FIG. 22 .

Referring to FIG. 1, the feature map may be quantized (S130).

In quantizing the feature map, a predetermined sixth parameter may be determined/used. Here, the sixth parameter may include at least one of a feature map average value (cast_avg), a feature map variance value (cast_var), a feature map minimum value (cast_min), or a feature map maximum value (cast_max).

The multiple/single feature map encoding step may include a feature map quantization step. The feature map quantization step may perform conversion from real numbers to integers for feature values.

In the neural network structure, a feature (value) of the feature map may be represented as either a real value or an integer value having a predetermined range. For example, when the number of feature map channels is C, the feature map may be composed of the predetermined number of feature values, and the predetermined number may be C × n′ × m′. A real number within a predetermined range may be 2¹²⁸ to 2⁻¹²⁸, and an integer value within a predetermined range may be one of 0 to 255, 0 to 511, and 0 to 1023.

Quantization may be performed using at least one of a feature average value (cast_avg), a feature variance value (cast_var), a feature range minimum value (cast_min), or a feature range maximum value (cast_max).

Here, the average feature value (cast_avg) refers to the average of feature values in the feature map channel of one or all feature maps. The feature average value (cast_avg) may be signaled. The feature variance value (cast_var) refers to the variance of feature values in the feature map channel of one or all feature maps. The feature variance value (cast_var) may be signaled. The feature range minimum value (cast_min) refers to the range minimum value of features in the feature map channel of one or all feature maps. The feature range minimum value (cast_min) may be signaled. The feature range maximum value (cast_max) refers to the range maximum value of features in the feature map channel of one or all feature maps. The feature range maximum value (cast_max) may be signaled.

For example, in the case of uniform quantization, quantization may be performed using at least one of a feature range minimum value (cast_min) or a feature range maximum value (cast_max).

For example, in the case of non-uniform quantization, quantization may be performed using at least one of the feature average value (cast_avg), the feature variance value (cast_var), the feature range minimum value (cast_min), or the feature range maximum value (cast_max).

Referring to FIG. 1, the feature map may be encoded (S140).

Here, the feature map may be any one of the feature map in step [D1], the fused feature map in step [D2], the packed feature map in step [D3], or the quantized feature map in step [D4].

In the encoding step, the size or number of channels of the feature map may be additionally reduced for the feature map. The encoded feature map may be inserted into a bitstream and transmitted to a decoding apparatus.

In the encoding step, at least one of information or syntax elements related to the feature map may be encoded. For example, at least one of the first to sixth parameters described above may be encoded. The first to sixth parameters may all be encoded as syntax elements. Alternatively, some parameters may be derived based on other parameters, and in this case, encoding of some parameters may be omitted.

In the encoding step, a predetermined seventh parameter may be determined/encoded. Here, the seventh parameter may include at least one of whether to reconstruct the multiple feature map (is_recon), a reconstruction method (is_top_down), whether to perform batch normalization (is_bn_dec_flag), an activation function mode (activation_func_{dec}), or whether to perform pooling (is_pooling ).

Specifically, a syntax element (is_recon) specifying whether to reconstruct the multiple feature map may be signaled. For example, when the syntax element is_recon is a first value, the multiple feature map may be reconstructed. When the syntax element is_recon is a second value, the multiple feature map may not be reconstructed. is_recon may be derived as a first value when the number of feature maps (num_of_f) is greater than 1. When is_multiscale_packing is a first value, is_recon may be derived as a first value.

A reconstruction method of the feature map may be selected as at least one of a bottom-up structure-based reconstruction method and a top-down structure-based reconstruction method. To this end, a syntax element (is_top_down) specifying a feature map reconstruction method may be signaled. For example, when the syntax element is_top_down is a first value, a top-down structure-based reconstruction method may be used. When the syntax element is_top_down is a second value, a bottom-up structure-based reconstruction method may be used.

In the feature map reconstruction step, a flag (is_bn_dec_flag) for determining whether to use batch normalization may be signaled. For example, when the syntax element is_bn_dec_flag is a first value, batch normalization may be used in the feature map reconstruction step. When the syntax element is_bn_dec_flag is a second value, batch normalization may not be used in the feature map reconstruction step. is_bn_dec_flag may always be derived as a first value without being signaled.

An activation function available in the feature map reconstruction step may be at least one of sigmoid, tanh, or PReLU. A syntax element (activation_func_{dec}) specifying an activation function used in the feature map reconstruction step may be signaled. For example, when the syntax element activation_func_{dec} is a first value, an activation function of sigmoid may be used in the feature map reconstruction step. When the syntax element activation_func_{dec} is a second value, an activation function of tanh may be used in the feature map reconstruction step. When the syntax element activation_func_{dec} is a third value, an activation function of PreLU may be used in the feature map reconstruction step.

In the feature map reconstruction step, a syntax element (is_pooling) specifying whether to perform pooling may be signaled. For example, when the syntax element is_pooling is a first value, pooling may be performed. When the syntax element is_pooling is a second value, pooling may not be performed.

FIG. 23 schematically illustrates a feature map decoding method performed by a decoding apparatus according to the present disclosure.

The feature map decoding method according to the present disclosure may comprise at least one of [D6] feature map decoding step, [D7] feature map inverse-quantization step, [D8] feature map inverse-packing step, or [D9] feature map reconstruction step. The neural network feature map may be decoded based on at least one of the first to seventh parameters described above. Feature map decoding may be performed in the reverse order of the feature map encoding described above, and redundant descriptions will be omitted here.

Referring to FIG. 23, a bitstream including the encoded feature map may be received (S2300).

The feature map may be extracted from at least one image. The feature map may be one or more features, a 2D feature map having a predetermined width and height, or a 3D feature map having a predetermined width, height, and channel size.

Referring to FIG. 23, the feature map may be decoded from a bitstream (S2310).

In the feature map decoding step, a channel of the decoded feature map may be enlarged. Specifically, the decoded feature map may be input to the convolution layer. A channel of the decoded feature map may be enlarged through the convolution layer. Through the channel enlargement process, the decoded feature map may have an enlarged channel size.

For example, in the feature map encoding step, the size (or number) of channels of the feature map may be reduced to a predetermined size. Here, the reduced size may be 8, 16, 32, 64, or more. An encoded feature map included in a bitstream may have a channel of the reduced size. A feature map decoded from a bitstream may have a channel of the same size as the reduced size. The size of the channel of the decoded feature map may be enlarged to a predetermined size. Here, the enlarged size may be the same as the size of the channel of the feature map input to the feature map encoding step.

The channel enlargement process may be performed when a channel reduction process is additionally performed on the feature map in the above-described feature map encoding step. Hereinafter, the decoded feature map may refer to a feature map in which the channel enlargement process is omitted or a feature map in which the size or number of channels is enlarged.

Referring to FIG. 23, the feature map may be inverse-quantized (S2320).

In the feature map inverse-quantization step, the feature map may be inverse-quantized based on at least one of the first to seventh parameters in the aforementioned steps [D1] to [D5]. Feature map inverse-quantization may be performed in the reverse order of feature map quantization. In the feature map inverse-quantization step, conversion of feature values from integers to real numbers may be performed.

A feature value that is an integer may be converted into a real number based on at least one of a feature average value (cast_avg), a feature variance value (cast_var), a feature range minimum value (cast_min), and a feature range maximum value (cast_max).

For example, based on the signaled feature average value (cast_avg), the average of feature values in the feature map channel of one or all feature maps may be derived. Based on the signaled feature variance value (cast_var), the variance of feature values in the feature map channel of one or all feature maps may be derived. Based on the signaled feature range minimum value (cast_min), a range minimum value of feature values in the feature map channel of one or all feature maps may be derived. Based on the signaled feature range maximum value (cast_max) of the signaled feature, the maximum value of feature values in the feature map channel of one or all feature maps may be derived.

Referring to FIG. 23 , the feature map may be inverse-packed (S2330).

In the feature map inverse-packing step, the feature map may be inverse-packed based on at least one of the first to seventh parameters in the aforementioned steps [D1] to [D5]. Feature map inverse-packing may be performed in the reverse order of feature map packing.

A single feature map may be temporally or spatially inverse-packed.

Based on the syntax element is_multiscale_packing, it may be determined whether the feature map to be inverse-packed is a single feature map.

At least one of the horizontal size n_{d}, the vertical size m_{d}, or the channel size Cₚᵣᵢₘₑ of the feature map to be output by the temporal inverse-packing method may be derived based on at least one of feature map horizontal size (packed_width), feature map vertical size (packed_height), or the number of frames of the feature map (packed_frames).

Based on at least one of the feature map horizontal size nₚ, the feature map vertical size mₚ, or the feature map channel size Cₚᵣᵢₘₑ before packing, the horizontal size n_{d}, the vertical size m_{d}, or channel size Cₚᵣᵢₘₑ of the feature map to be output by the spatial inverse-packing method may be derived..

The multiple feature map may be temporally or spatially inverse-packed. The multiple feature map inverse-packing process may be performed in the reverse order of the multiple feature map packing process.

Based on the syntax element is_multiscale_packing, it may be determined whether the feature map to be inverse-packed is a single feature map.

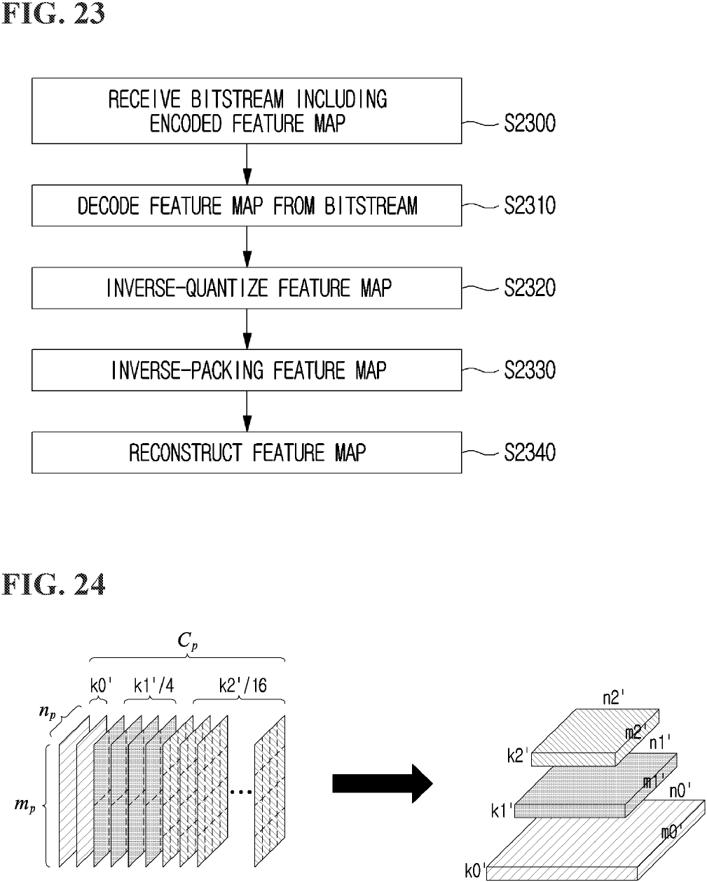

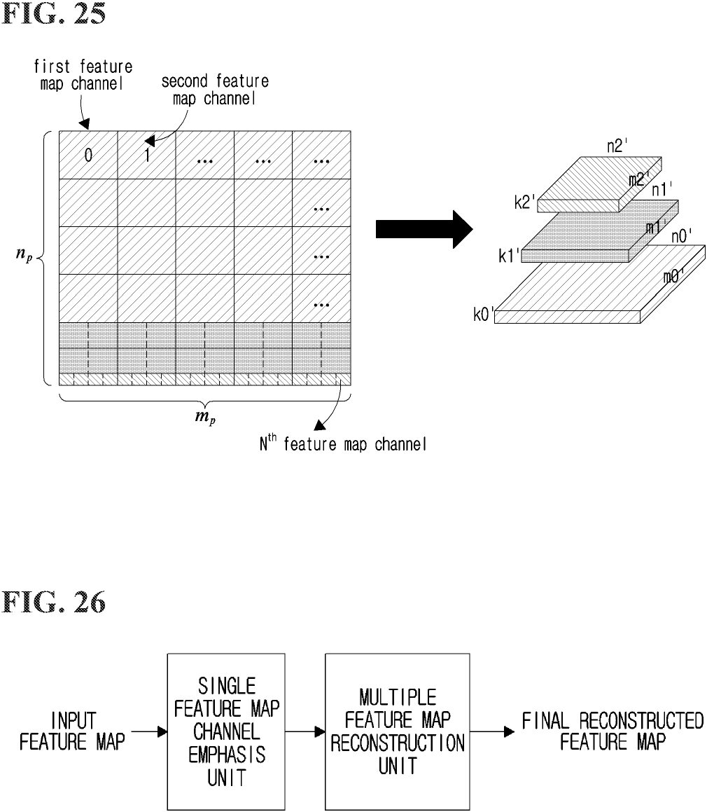

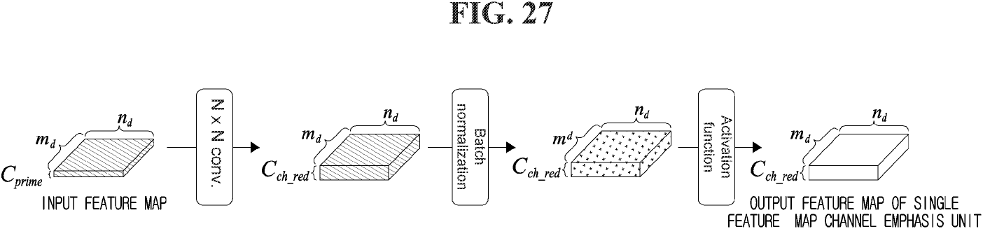

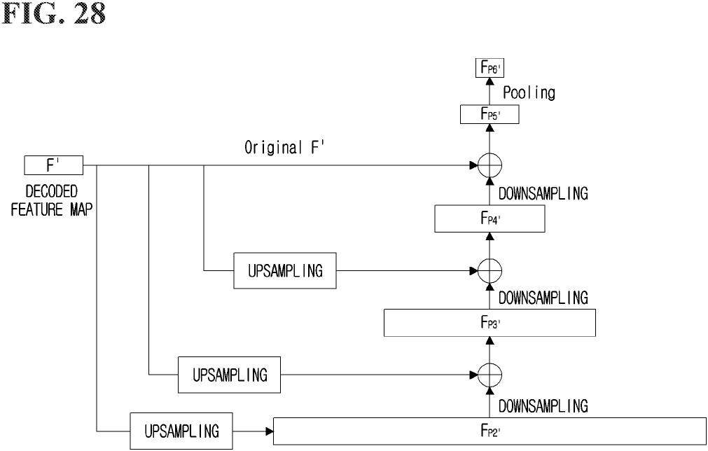

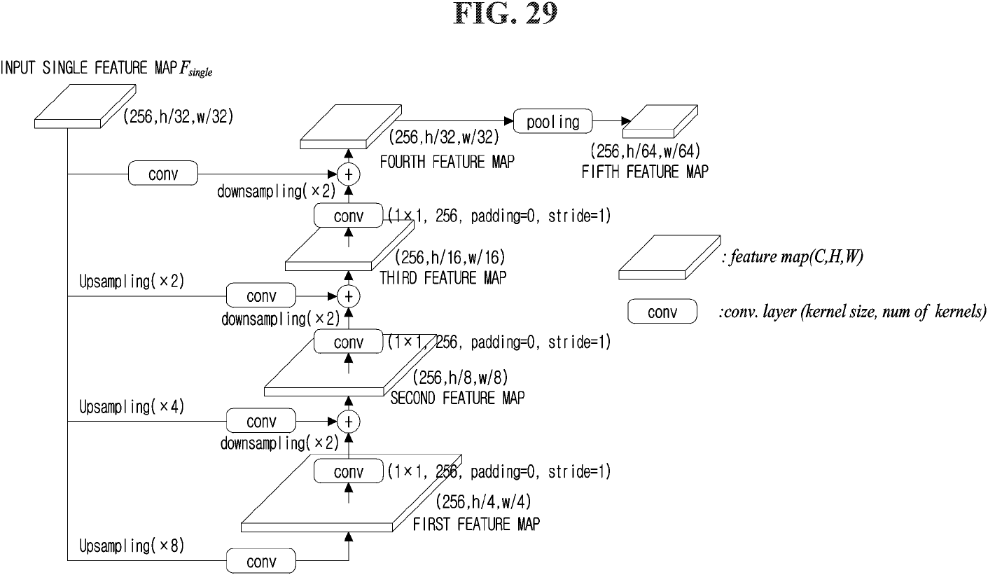

Temporal inverse-packing may be performed on the multiple feature map. For example, as shown in FIG. 24, spatial inverse-packing may be performed after temporal inverse-packing. When temporal inverse-packing is performed, a single feature map may be inverse-packed in the form of the multiple feature map.

Spatial inverse-packing may be performed on the multiple feature map. For example, spatial inverse-packing may be performed as shown in FIG. 25. When spatial inverse-packing is performed, a single feature map may be inverse-packed in the form of the multiple feature map.

Referring to FIG. 23, the feature map may be reconstructed (S2340).

In the feature map reconstruction step, a feature map corresponding to each layer of the neural network may be reconstructed. The neural network may mean a feature pyramid network (FPN), and the layer may mean P-layers of the FPN. The neural network may be used in an encoding apparatus to extract a feature map from an input image. When a plurality of layers are used, each layer may be identified by an index. For convenience of explanation, it is assumed that P2, P3, P4, and P5 are used as P-layers of the neural network in the present disclosure. Here, P2 may mean the lowest layer among P-layers, and P5 may mean the highest layer among P-layers.

Sizes of feature maps extracted for each layer may be different from each other. For example, the lowest layer P2 may mean a layer from which a feature map having the largest size is extracted, and the highest layer P5 may mean a layer from which a feature map having the smallest size is extracted. In this case, the size of the feature map extracted from the P3 layer may be half the size of the feature map extracted from the P2 layer. The size of the feature map extracted from the P4 layer may be half the size of a feature map extracted from the P3 layer. The size of the feature map extracted from the P5 layer may be half the size of a feature map extracted from the P4 layer.

In the feature map reconstruction step, the feature map may be reconstructed based on at least one of the first to seventh parameters in the above-mentioned steps [D1] to [D5]. As shown in FIG. 29, the feature map reconstruction step may include at least one of a channel enlargement step of a single feature map in a single feature map channel enlargement unit and a reconstruction step of a multiple feature map in a multiple feature map reconstruction unit.

The single feature map channel enlargement unit may reconstruct reduced channel information by enlarging the number of channels of the single feature map. An input of the single feature map channel enlargement unit may be the single/multiple feature map obtained in step [D8]. In the single feature map channel enlargement unit, the number of channels may be increased from Cₚᵣᵢₘₑ to C_{ch_red}. To this end, at least one of batch normalization or activation function may be performed. In the multiple feature map reconstruction unit, the single feature map may be reconstructed into the multiple feature map.

Specifically, in the single feature map channel enlargement unit, the size of a channel of a feature map whose size has been reduced in the encoding apparatus may be reconstructed. The feature map channel enlargement unit may enlarge the size of a channel of a feature map by using an N×N convolution layer.

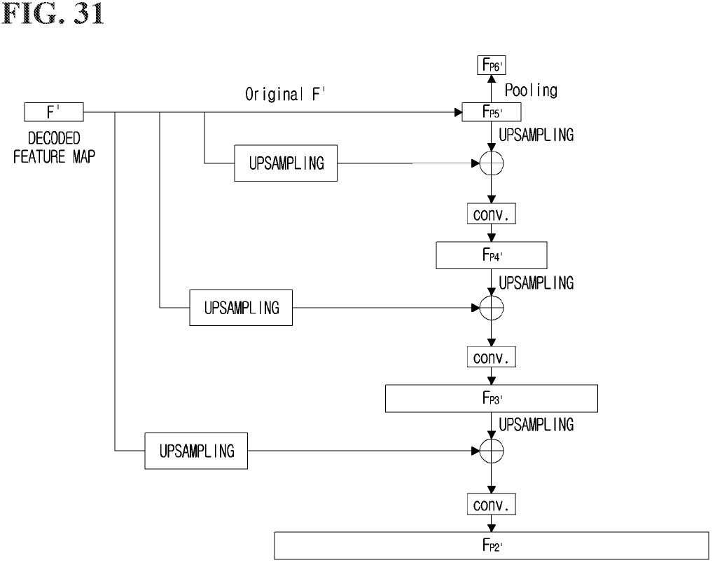

As shown in FIG. 30, the kernel of the N×N convolution layer may be at least one of 1×1, 3×3, or 5×5, and padding may be applied by (N-1)/2. For example, when an 1×1 convolution layer is used, padding may be 0. When a 3×3 convolution layer is used, padding may be 1. When a 5×5 convolution layer is used, padding may be 2.

As shown in FIG. 30, the number of kernels of the N×N convolution layer may be derived based on at least one of C_{ch_red} or C_{comb}. For example, the number of kernels of the N×N convolution layer may be derived as at least one of C_{comb}, C_{comb} /2, C_{comb} /4, or C_{comb} /8.

The data distribution of a feature map with the enlarged channel size may be changed based on at least one of batch normalization or activation function. For example, whether to perform batch normalization may be determined based on the syntax element is_bn_dec_flag. The activation function may be determined based on the syntax element activation_function_{dec}. When activation_function_{dec} is a first value, the activation function may be determined as Sigmoid. When activation_function_{dec} is a second value, the activation function may be determined as tanh. When activation_function_{dec} is a third value, the activation function may be determined as PReLU.

The multiple feature map reconstruction unit may reconstruct the single feature map in the form of the multiple feature map. The input single feature map F_{single} has a horizontal size n_{d}, a vertical size m_{d}, and a channel size C_{ch_red}. Whether to reconstruct the multiple feature map may be determined based on the syntax element is_recon. A reconstruction method of the multiple feature map may be determined as one of a top-down structure-based reconstruction method or a bottom-up structure-based reconstruction method by a syntax element is_top_down. For example, when is_top_down is a first value, a top-down structure-based reconstruction method may be used to reconstruct the multiple feature map. When is_top_down is a second value, a bottom-up structure-based reconstruction method may be used to reconstruct the multiple feature map. Alternatively, one of a first reconstruction method and a second reconstruction method may be implicitly selected based on the properties of the encoded feature map. Here, the properties of the encoded feature map may mean the size (e.g., width, height, channel size) of the feature map, whether to use multi-layers, the number/location of multi-layers, and the like.

The single feature map may be reconstructed into the multiple feature map having N feature maps. Here, the number N of reconstructed feature maps may be derived based on the syntax element num_of_f. Hereinafter, the order of a first feature map, a second feature map, ..., the N-th feature map is defined in order from the largest to the smallest horizontal and vertical sizes.

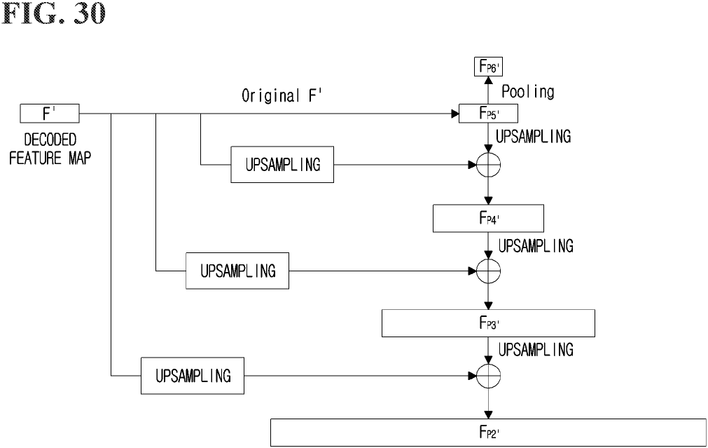

The bottom-up structure-based reconstruction method may refers to a method of reconstructing the multiple feature map in the order of a first feature map, a second feature map, ... , an N-th feature map. The bottom-up structure may refer to a method of reconstructing feature maps corresponding to each layer in the order from the lowest layer to the highest layer. Alternatively, the bottom-up structure may refer to a method of reconstructing feature maps in descending order of feature map sizes. That is, it may refer to a method of reconstructing features in the order from a feature map having the largest size to a feature map having the smallest size. Alternatively, the bottom-up structure may refer to a method of reconstructing features in an ascending order of indices assigned to each layer. Hereinafter, a feature map reconstruction method based on a bottom-up structure will be described in detail with reference to FIGS. 28 and 29.

FIG. 28 illustrates a feature map reconstruction method based on a bottom-up structure according to the present disclosure.

Referring to FIG. 28, F′ may mean a decoded feature map. F_{P2}’, F_{P3}’, F_{P4}’, and F_{P5}’ may mean reconstructed feature maps corresponding to P2, P3, P4, and P5 layers, respectively.

First, a first feature map F_{P2}′ corresponding to the P2 layer, which is the lowest layer, may be reconstructed from the decoded feature map F′. In this case, the first feature map may be reconstructed by upsampling the decoded feature map. As an upsampling technique, nearest neighboring interpolation (nn.interpolation) or pixel shuffle (nn.PixelShuffle) may be used. The same upsampling technique may be used in embodiments to be described later, and redundant description will be omitted.

A scaling factor for upsampling may be determined based on a ratio between the feature map size of the reference layer and the feature map size of the P2 layer. For example, the reference layer may be the highest layer (P5) among the P-layers described above. Assuming that the feature map size of the P5 layer is 1 and the feature map size of the P2 layer is 8, the first feature map may be reconstructed by upsampling the decoded feature map based on a scaling factor of 8.

Then, based on at least one of the decoded feature map F′ or the pre-reconstructed feature map of the previous layer (i.e., the first feature map), a second feature map (F_{P3}′) corresponding to the P3 layer may be reconstructed.

Specifically, the decoded feature map may be upsampled based on a predetermined scaling factor. Here, as described above, the scaling factor may be determined based on the ratio between the feature map size of the reference layer and the feature map size of the P3 layer. The pre-reconstructed first feature map may be downsampled. Here, a scaling factor for downsampling may be determined based on a ratio between the feature map size of the P2 layer and the feature map size of the P3 layer. The second feature map may be reconstructed based on the sum of the upsampled decoded feature map and the downsampled first feature map.

The previous layer means a layer reconstructed right before the current layer, but is not limited thereto. For example, the previous layer may be any one of a plurality of layers reconstructed before the current layer. The previous layer may be limited to the aforementioned reference layer. A ‘previous layer’ described later may be interpreted in the same meaning.

The third feature map (F_{P4}′) corresponding to the P4 layer may be reconstructed based on at least one of the decoded feature map F′ or the pre-reconstructed feature map of the previous layer (i.e., the second feature map).

Specifically, the decoded feature map may be upsampled based on a predetermined scaling factor. Here, the scaling factor may be determined based on a ratio between the feature map size of the reference layer and the feature map size of the P4 layer. The pre-reconstructed second feature map may be downsampled. Here, a scaling factor for downsampling may be determined based on a ratio between the feature map size of the P3 layer and the feature map size of the P4 layer. The third feature map may be reconstructed based on the sum of the upsampled decoded feature map and the downsampled second feature map.

The fourth feature map (F_{P5}′) corresponding to the P5 layer, which is the highest layer, may be reconstructed based on at least one of the decoded feature map (F′) or the pre-reconstructed feature map (i.e., the third feature map) of the previous layer.

Specifically, the pre-reconstructed third feature map may be downsampled. Here, a scaling factor for downsampling may be determined based on a ratio between the feature map size of the P4 layer and the feature map size of the P5 layer. The fourth feature map may be reconstructed based on the sum of the decoded feature map and the downsampled third feature map. In case of reconstructing the feature map corresponding to the highest layer, the process of upsampling the decoded feature map may be omitted.

FIG. 29 illustrates a feature map reconstruction method based on a bottom-up structure according to the present disclosure.

Referring to FIG. 29, the bottom-up structure-based reconstruction method may reconstruct the multiple feature map in the order of a first feature map, a second feature map, a third feature map, and a fourth feature map. In the bottom-up structure-based reconstruction method, the first feature map may be reconstructed by applying upsampling to an input single feature map. After upsampling, an additional N×N convolution layer may be applied.

Specifically, F_{up,s} may be obtained by applying 2^{(num_of_f-1)} times upsampling to F_{single}. When num_of_f is 3, twice upsampling may be applied to the first feature map.

Then, F_{conv,s} may be obtained by applying an N×N convolution layer to F_{up,s}. Here, the kernel size of the N×N convolution layer may be at least one of 1×1, 3×3, or 5×5. The number of kernels of the N×N convolution layer may be equal to the channel size k₀ of the first feature map layer. k₀ may be signaled. The F_{conv,s} may be the reconstructed first feature map.

As shown in FIG. 29, in the bottom-up structure-based reconstruction method, the i-th feature map (2≤i≤N) may be reconstructed by the following process.

F_{up,s} may be obtained by applying 2^{(num_of_f-1)-i} times upsampling to F_{single}. F_{conv,s} may be obtained by applying an N×N convolution layer to F_{up,s}. Here, the kernel size of the N×N convolution layer may be at least one of 1×1, 3×3, or 5×5. The number of kernels of the N×N convolution layer may be equal to the channel size kᵢ₋₁ of the i-th feature map layer. kᵢ₋₁ may be signaled.

F_{down,}ᵢ₋₁ may be obtained by applying (½) times downsampling to the reconstructed the (i-1)-th feature map. F_{conv.i-1} may be obtained by applying an N×N convolution layer to F_{down,}ᵢ₋₁. Here, the kernel size of the N×N convolution layer may be at least one of 1×1, 3×3, or 5×5. The number of kernels of the N×N convolution layer may be equal to the channel size kᵢ₋₁ of the i-th feature map layer. kᵢ₋₁ may be signaled.

Based on F_{conv,s} and F_{conv.i-1}, a reconstructed i-th feature map may be obtained. For example, a reconstructed i-th feature map may be obtained through a pixel-wise sum between F_{conv,s} and F_{conv.i-1}.

In the bottom-up structure-based reconstruction method, an additional feature map may be reconstructed. The additional feature map may be obtained by applying (½) times downsampling to at least one of the first to N-th feature maps.

For example, as shown in FIG. 29, a fifth feature map, which is an additional feature map, may be obtained by applying (½) times downsampling to the reconstructed fourth feature map. Here, pooling may be applied as one of the downsampling methods. However, whether or not to reconstruct the additional feature map may be adaptively determined based on the syntax element is_pooling.

Meanwhile, the top-down structure-based reconstruction method may refer to a method of reconstructing the multiple feature map in the order of an N-th feature map, an (N-1)-th feature map, ... , a first feature map. The top-down structure may refer to a method of reconstructing feature maps corresponding to each layer in the order from the highest layer to the lowest layer. Alternatively, the top-down structure may refer to a method of reconstructing feature maps in ascending order of feature map size. That is, it may refer to a method of reconstructing feature maps in the order from a feature map having the smallest size to a feature map having the largest size. Alternatively, the top-down structure may refer to a method of reconstructing features in descending order of indices assigned to each layer. Hereinafter, a feature map reconstruction method based on a top-down structure will be described in detail with reference to FIGS. 30 to 32 .

FIG. 30 illustrates a feature map reconstruction method based on a top-down structure according to the present disclosure.

Referring to FIG. 30, F′ may mean a decoded feature map. F_{P2}′, F_{P3}′, F_{P4}′, and F_{P5}′ may mean reconstructed feature maps corresponding to P2, P3, P4, and P5 layers, respectively.

First, a first feature map F_{P5}′ corresponding to the P5 layer, which is the highest layer, may be reconstructed from the decoded feature map F′. For example, the decoded feature map may be identically set as the first feature map corresponding to the P5 layer.

Then, based on at least one of the decoded feature map F′ or the pre-reconstructed feature map of the previous layer (i.e., the first feature map), a second feature map F_{P4̂̂̂′}̂̂̂̂ corresponding to the P4 layer may be reconstructed.

Specifically, the decoded feature map may be upsampled based on a predetermined scaling factor. Here, the scaling factor may be determined based on a ratio between the feature map size of the reference layer and the feature map size of the P4 layer. The reference layer may be the highest layer P5 among the aforementioned P-layers. Additionally, the pre-reconstructed first feature map of the previous layer may be upsampled. Here, a scaling factor for upsampling may be determined based on a ratio between the feature map size of the P5 layer and the feature map size of the P4 layer. The second feature map corresponding to the P4 layer may be reconstructed based on the sum of the upsampled decoded feature map and the upsampled first feature map.

Similarly, the third feature map F_{P3}′ corresponding to the P3 layer may be reconstructed based on at least one of the decoded feature map F′ or the pre-reconstructed feature map of the previous layer (i.e., the second feature map).

Specifically, the decoded feature map may be upsampled based on a predetermined scaling factor. Here, the scaling factor may be determined based on a ratio between the feature map size of the reference layer and the feature map size of the P3 layer. Additionally, the pre-reconstructed second feature map of the previous layer may be upsampled. Here, a scaling factor for upsampling may be determined based on a ratio between the feature map size of the P4 layer and the feature map size of the P3 layer. The third feature map corresponding to the P3 layer may be reconstructed based on the sum of the upsampled decoded feature map and the upsampled second feature map.

The fourth feature map F_{P2}′ corresponding to the P2 layer, which is the lowest layer, may be reconstructed based on at least one of the decoded feature map F′ or the pre-reconstructed feature map of the previous layer (i.e., the third feature map).

Specifically, the decoded feature map may be upsampled based on a predetermined scaling factor. Here, the scaling factor may be determined based on a ratio between the feature map size of the reference layer and the feature map size of the P2 layer. Additionally, the pre-reconstructed third feature map of the previous layer may be upsampled. Here, a scaling factor for upsampling may be determined based on a ratio between the feature map size of the P3 layer and the feature map size of the P2 layer. The fourth feature map corresponding to the P2 layer may be reconstructed based on the sum of the upsampled decoded feature map and the upsampled third feature map.

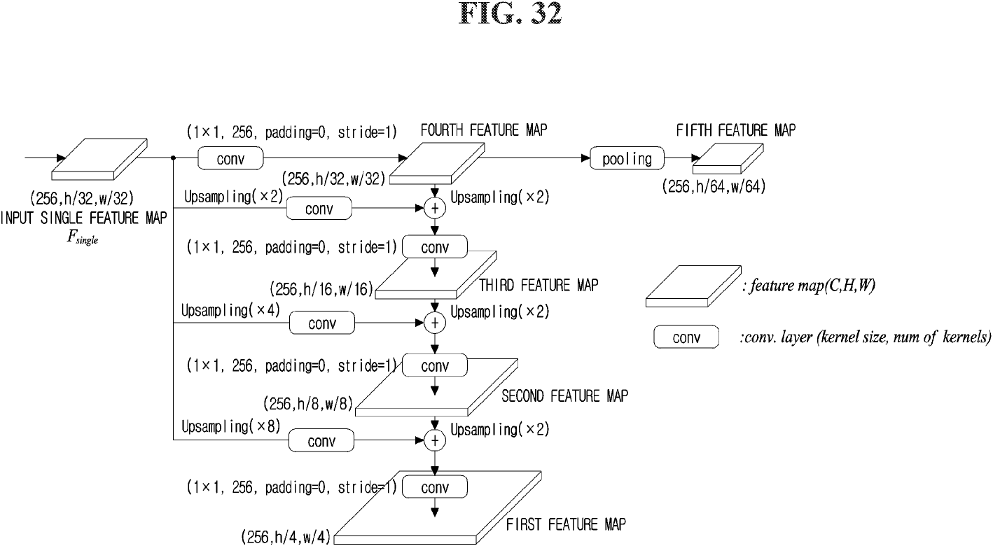

FIG. 31 illustrates a feature map reconstruction method based on a top-down structure according to the present disclosure.

Referring to FIG. 31, F′ may mean a decoded feature map. F_{P2}′, F_{P3}′, F_{P4}′, and F_{P5}′ may mean reconstructed feature maps corresponding to P2, P3, P4, and P5 layers, respectively.

First, a first feature map F_{P5}′ corresponding to the P5 layer, which is the highest layer, may be reconstructed from the decoded feature map F′. For example, the decoded feature map may be identically set as the first feature map corresponding to the P5 layer.

Then, based on at least one of the decoded feature map F′ or the pre-reconstructed feature map of the previous layer (i.e., the first feature map), a second feature map F_{P4}′ corresponding to the P4 layer may be reconstructed.

Specifically, the decoded feature map may be upsampled based on a predetermined scaling factor. Here, the scaling factor may be determined based on a ratio between the feature map size of the reference layer and the feature map size of the P4 layer. The reference layer may be the highest layer P5 among the aforementioned P-layers. Additionally, the pre-reconstructed first feature map of the previous layer may be upsampled. Here, a scaling factor for upsampling may be determined based on a ratio between the feature map size of the P5 layer and the feature map size of the P4 layer.

The sum of the upsampled decoded feature map and the upsampled first feature map may be input to the convolution layer. The convolution layer may perform convolution on a sum of the upsampled decoded feature map and the upsampled first feature map. The reconstructed second feature map corresponding to the P4 layer may be reconstructed based on the output of the convolution layer.

Similarly, the third feature map F_{P3}′ corresponding to the P3 layer may be reconstructed based on at least one of the decoded feature map F′ or the pre-reconstructed feature map of the previous layer (i.e., the second feature map).

Specifically, the decoded feature map may be upsampled based on a predetermined scaling factor. Here, the scaling factor may be determined based on a ratio between the feature map size of the reference layer and the feature map size of the P3 layer. Additionally, the pre-reconstructed second feature map of the previous layer may be upsampled. Here, a scaling factor for upsampling may be determined based on a ratio between the feature map size of the P4 layer and the feature map size of the P3 layer.

The sum of the upsampled decoded feature map and the upsampled second feature map may be input to the convolution layer. The convolution layer may perform convolution on the sum of the upsampled decoded feature map and the upsampled second feature map. The reconstructed third feature map corresponding to the P3 layer may be reconstructed based on the output of the convolution layer.

The fourth feature map F_{P2}′ corresponding to the P2 layer, which is the lowest layer, may be reconstructed based on at least one of the decoded feature map F′ or the pre-reconstructed feature map of the previous layer (i.e., the third feature map).

Specifically, the decoded feature map may be upsampled based on a predetermined scaling factor. Here, the scaling factor may be determined based on a ratio between the feature map size of the reference layer and the feature map size of the P2 layer. Additionally, the pre-reconstructed third feature map of the previous layer may be upsampled. Here, a scaling factor for upsampling may be determined based on a ratio between the feature map size of the P3 layer and the feature map size of the P2 layer.

The sum of the upsampled decoded feature map and the upsampled third feature map may be input to the convolution layer. The convolution layer may perform convolution on a sum of the upsampled decoded feature map and the upsampled third feature map. The reconstructed fourth feature map corresponding to the P2 layer may be reconstructed based on the output of the convolution layer.

FIG. 32 illustrates a feature map reconstruction method based on a top-down structure according to the present disclosure.

Referring to FIG. 32, the top-down structure-based reconstruction method may reconstruct the multiple feature map in the order of a fourth feature map, a third feature map, a second feature map, and a first feature map. In the top-down structure-based reconstruction method, the N-th feature map may be reconstructed by applying an N×N convolution layer to an input single feature map.

Specifically, F_{conv,s} may be obtained by applying an N×N convolution layer to F_{single}. Here, the kernel size of the N×N convolution layer may be at least one of 1×1, 3×3, or 5×5. The number of kernels of the N×N convolution layer may be equal to the channel size k_{N-1} of the N-th feature map layer. k_{N-1} may be signaled. Alternatively, k_{N-1} may be equal to the channel size of F_{single}. The F_{conv,s} may be the reconstructed N-th feature map.

As shown in FIG. 32, in the top-down structure-based reconstruction method, the i-th feature map (1≤i≤N-1) may be reconstructed by the following process.

F_{up,s} may be obtained by applying 2^{N-i} times upsampling to F_{single}. F_{conv,s} may be obtained by applying an N×N convolution layer to F_{up,s}. Here, the kernel size of the N×N convolution layer may be at least one of 1×1, 3×3, or 5×5. The number of kernels of the N×N convolution layer may be equal to the channel size kᵢ₋₁ of the i-th feature map layer. kᵢ₋₁ may be signaled. Alternatively, kᵢ₋₁ may be equal to the channel size of F_{single}.

F_{up,}ᵢ₊₁ may be obtained by applying two times upsampling to the reconstructed (i+1)-th feature map.

F_{sum,}ᵢ may be obtained based on the F_{conv,s} and F_{up,}ᵢ₊₁. For example, Fₛᵤₘ, ᵢ may be obtained through a pixel-wise sum between F_{conv,s} and F_{up,}ᵢ₊₁.

F_{conv.i} may be obtained by applying an N×N convolution layer to F_{sum,}ᵢ. Here, the kernel size of the N×N convolution layer may be at least one of 1×1, 3×3, or 5×5. The number of kernels of the N×N convolution layer may be equal to the channel size kᵢ₋₁ of the i-th feature map layer. kᵢ₋₁ may be signaled. Alternatively, kᵢ₋₁ may be equal to the channel size of F_{single}. The F_{conv.i} may be a reconstructed i-th feature map.

An additional feature map may be reconstructed in the top-down reconstruction method. The additional feature map may be obtained by applying (½) times downsampling to at least one of the first to N-th feature maps.

For example, as shown in FIG. 32, a fifth feature map, which is an additional feature map, may be obtained by applying (½) times downsampling to the reconstructed fourth feature map. Here, pooling may be applied as one of the downsampling methods. However, whether or not to reconstruct the additional feature map may be adaptively determined based on the syntax element is_pooling.

The components described in the example embodiments may be implemented by hardware components including, for example, at least one digital signal processor (DSP), a processor, a controller, an application-specific integrated circuit (ASIC), a programmable logic element, such as an FPGA, GPU other electronic devices, or combinations thereof. At least some of the functions or the processes described in the example embodiments may be implemented by software, and the software may be recorded on a recording medium. The components, the functions, and the processes described in the example embodiments may be implemented by a combination of hardware and software.

The method according to example embodiments may be embodied as a program that is executable by a computer, and may be implemented as various recording media such as a magnetic storage medium, an optical reading medium, and a digital storage medium.

Various techniques described herein may be implemented as digital electronic circuitry, or as computer hardware, firmware, software, or combinations thereof. The techniques may be implemented as a computer program product, i.e., a computer program tangibly embodied in an information carrier, e.g., in a machine-readable storage device (for example, a computer-readable medium) or in a propagated signal for processing by, or to control an operation of a data processing apparatus, e.g., a programmable processor, a computer, or multiple computers. A computer program(s) may be written in any form of a programming language, including compiled or interpreted languages and may be deployed in any form including a stand-alone program or a module, a component, a subroutine, or other units suitable for use in a computing environment. A computer program may be deployed to be executed on one computer or on multiple computers at one site or distributed across multiple sites and interconnected by a communication network.

Processors suitable for execution of a computer program include, by way of example, both general and special purpose microprocessors, and any one or more processors of any kind of digital computer. Generally, a processor will receive instructions and data from a read-only memory or a random access memory or both. Elements of a computer may include at least one processor to execute instructions and one or more memory devices to store instructions and data. Generally, a computer will also include or be coupled to receive data from, transfer data to, or perform both on one or more mass storage devices to store data, e.g., magnetic, magneto-optical disks, or optical disks. Examples of information carriers suitable for embodying computer program instructions and data include semiconductor memory devices, for example, magnetic media such as a hard disk, a floppy disk, and a magnetic tape, optical media such as a compact disk read only memory (CD-ROM), a digital video disk (DVD), etc. and magneto-optical media such as a floptical disk, and a read only memory (ROM), a random access memory (RAM), a flash memory, an erasable programmable ROM (EPROM), and an electrically erasable programmable ROM (EEPROM) and any other known computer readable medium. A processor and a memory may be supplemented by, or integrated into, a special purpose logic circuit.

The processor may run an operating system (OS) and one or more software applications that run on the OS. The processor device also may access, store, manipulate, process, and create data in response to execution of the software. For purpose of simplicity, the description of a processor device is used as singular; however, one skilled in the art will be appreciated that a processor device may include multiple processing elements and/or multiple types of processing elements. For example, a processor device may include multiple processors or a processor and a controller. In addition, different processing configurations are possible, such as parallel processors.

Also, non-transitory computer-readable media may be any available media that may be accessed by a computer, and may include both computer storage media and transmission media.

The present specification includes details of a number of specific implements, but it should be understood that the details do not limit any invention or what is claimable in the specification but rather describe features of the specific example embodiment. Features described in the specification in the context of individual example embodiments may be implemented as a combination in a single example embodiment. In contrast, various features described in the specification in the context of a single example embodiment may be implemented in multiple example embodiments individually or in an appropriate sub-combination. Furthermore, the features may operate in a specific combination and may be initially described as claimed in the combination, but one or more features may be excluded from the claimed combination in some cases, and the claimed combination may be changed into a sub-combination or a modification of a sub-combination.

Similarly, even though operations are described in a specific order on the drawings, it should not be understood as the operations needing to be performed in the specific order or in sequence to obtain desired results or as all the operations needing to be performed. In a specific case, multitasking and parallel processing may be advantageous. In addition, it should not be understood as requiring a separation of various apparatus components in the above described example embodiments in all example embodiments, and it should be understood that the above-described program components and apparatuses may be incorporated into a single software product or may be packaged in multiple software products.

It should be understood that the example embodiments disclosed herein are merely illustrative and are not intended to limit the scope of the invention. It will be apparent to one of ordinary skill in the art that various modifications of the example embodiments may be made without departing from the spirit and scope of the claims and their equivalents.

What is claimed is:

1. A method of decoding a neural network feature, comprising:
receiving a bitstream including an encoded feature, the encoded feature including one or more features extracted from at least one image;
decoding the feature from the bitstream; and
reconstructing features corresponding to a plurality of layers of a neural network based on the decoded feature.

2. The method of claim 1, wherein the features corresponding to the plurality of layers are reconstructed according to a reconstruction order of a bottom-up structure.

3. The method of claim 2, wherein the bottom-up structure is a structure in which a feature corresponding to each layer is reconstructed in order from a lowest layer to a highest layer among the plurality of layers.

4. The method of claim 3, wherein reconstructing the features comprises:
reconstructing, from the decoded feature, a first feature corresponding to a first layer among the plurality of layers; and
reconstructing a second feature corresponding to a second layer among the plurality of layers based on at least one of the decoded feature or the first feature of the first layer,
wherein the first feature of the first layer has a larger size than the second feature of the second layer.

5. The method of claim 4, wherein the first feature is reconstructed by upsampling the decoded feature, and
wherein the upsampling is performed based on one of nearest neighbor interpolation or pixel shuffle.

6. The method of claim 4, wherein reconstructing the second feature comprises:
upsampling the decoded feature; and
downsampling the pre-reconstructed first feature,
wherein the second feature is reconstructed based on a sum of the upsampled decoded feature and the downsampled first feature.

7. The method of claim 6, wherein a scaling factor for the upsampling is determined based on a ratio between a feature size corresponding to a reference layer and a feature size corresponding to the second layer, the reference layer being the highest layer among the plurality of layers, and
wherein a scaling factor for the downsampling is determined based on a ratio between a feature size corresponding to the first layer and the feature size corresponding to the second layer.

8. The method of claim 1, wherein the features corresponding to the plurality of layers are reconstructed according to a reconstruction order of a top-down structure.

9. The method of claim 8, wherein the top-down structure is a structure in which a feature corresponding to each layer is reconstructed in an order from a highest layer to a lowermost layer among the plurality of layers.

10. The method of claim 9, wherein reconstructing the features comprises:
reconstructing, from the decoded feature, a first feature corresponding to a first layer among the plurality of layers; and
recontructing a second feature corresponding to a second layer among the plurality of layers based on at least one of the decoded feature or the first feature of the first layer,
wherein the first feature of the first layer has a smaller size than the second feature of the second layer.

11. The method of claim 10, wherein the decoded feature is set equal to the first feature corresponding to the first layer.

12. The method of claim 10, wherein reconstructing the second feature comprises:
upsampling the decoded feature;
upsampling the pre-reconstructed first feature; and
calculating a sum of the upsampled decoded feature and the upsampled first feature.

13. The method of claim 12, wherein the upsampling is performed based on one of nearest neighbor interpolation or pixel shuffle.

14. The method of claim 12, wherein a scaling factor for upsampling the decoded feature is determined based on a ratio between a feature size corresponding to a reference layer and a feature size corresponding to the second layer, the reference layer being the highest layer among the plurality of layers, and
wherein a scaling factor for upsampling the pre-reconstructed first feature is determined based on a ratio between a feature size corresponding to the first layer and a feature size corresponding to the second layer.

15. The method of claim 12, wherein reconstructing the second feature further comprises:
performing convolution on a sum of the upsampled decoded feature and the upsampled first feature.

16. An apparatus of decoding a neural network feature, comprising:
a receiving unit configured to receive a bitstream including an encoded feature, the encoded feature including one or more features extracted from at least one image;
a decoding unit configured to decode the feature from the bitstream; and
a reconstructing unit configured to reconstruct features corresponding to a plurality of layers of a neural network based on the decoded feature.

17. A non-transitory computer-readable storage medium for storing a bitstream to be decoded by a neural network feature decoding method,
the neural network feature decoding method comprising:
receiving a bitstream including an encoded feature, the encoded feature including one or more features extracted from at least one image;
decoding the feature from the bitstream; and
reconstructing features corresponding to a plurality of layers of a neural network based on the decoded feature.
